(19) United States
(12) Patent Application Publication
(10) Pub. No.: US 2024/0231471 A1
(43) Pub. Date: Jul. 11, 2024

(54) ARTIFICIAL REALITY SYSTEM HAVING A SYSTEM ON A CHIP WITH AN INTEGRATED REDUCED POWER MICROCONTROLLER AND APPLICATION TRANSITION

(71) Applicant: Meta Platforms Technologies, LLC, Menlo Park, CA (US)

(72) Inventors: Shrirang Madhav Yardi, San Jose, CA (US); Dinesh Patil, Sunnyvale, CA (US); Neeraj Upasani, Sammamish, WA (US)

(21) Appl. No.: 18/410,552

(22) Filed: Jan. 11, 2024

Related U.S. Application Data
(60) Provisional application No. 63/479,469, filed on Jan. 11, 2023.

(51) Int. Cl. G06F 1/3293

(52) U.S. Cl. CPC G06F 1/3293

(57) ABSTRACT

A system on a chip (SoC) comprises SoC memory; one or more processor subsystems, wherein each processor subsystem includes a processor connected to the SoC memory; and a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem, wherein the low power subsystem is configured to boot up the SoC via the microcontroller executing out of SoC memory.

This application claims the benefit of U.S. Provisional Application No. 63/479,469, filed 11 Jan. 2023, the entire contents of which is incorporated herein by reference.

### TECHNICAL FIELD

This disclosure generally relates to artificial reality systems and, in particular, to systems and methods for reduced power processing in a system on a chip.

### BACKGROUND

Artificial reality is a form of reality that has been adjusted in some manner before presentation to a user, which may include, e.g., a virtual reality, an augmented reality, a mixed reality, a hybrid reality, or some combination and/or derivatives thereof. Artificial reality systems include one or more devices for rendering and displaying content to users. Examples of artificial reality systems may incorporate a head-mounted display (HMD) worn by a user and configured to output artificial reality content to the user. In some examples, the HMD may be coupled (e.g., wirelessly or in tethered fashion) to a peripheral device that performs one or more artificial reality-related functions.

Some artificial reality systems include a system on a chip (SoC) having a central processor unit (CPU). In some such artificial reality systems, low-power chipsets may be used separate from the SoC CPU to perform selected functions more efficiently. In some approaches, the low-power chipsets are integrated on a die separate from the SoC, such as on a scaled-down SoC that provides some functionality (usually a sensor hub or a Wi-Fi module). In operation, the SoC CPU boots and executes software up until the SoC CPU determines that one or more lower-cost hardware sets (such as low-power chipsets) can execute the software more power efficiently. The CPU then transitions the remaining tasks to the low-power chipsets. Such transitions, however, take time and energy, because the state of current processes must be conveyed from the CPU to the low-power chipsets, and vice versa.

### SUMMARY

In general, this disclosure is directed to a low-power subsystem, such as a mini-SoC, integrated with an SoC of an artificial reality system, the low-power subsystem executing software within the artificial reality system until the SoC CPU is needed. A typical wearable device or smartphone SoC has a small low power or “always on” portion of the chip that performs boot and security functions to facilitate operation of the main portion of the chip to execute user-facing workloads for full applications. That is, executing user applications requires the full SoC operate, not just the small lower power portion, and the full stack operating system be booted on the main CPU of the SoC. However, this consumes a significant amount of power.

The low-power subsystem may perform boot, security, power management, etc., functions as does a typical lower power portion of an SoC. As described herein, the low-power subsystem additionally supports applications without requiring participation by the higher power portions of the rest of the SoC, such as the SoC CPU(s). This “mini-SoC” is optimized to run a small subset of applications at a fraction of the power that would otherwise be needed, thus extending the battery life of artificial reality devices.

In examples of the described techniques, the low-power subsystem has the following functionality and properties: First, the low-power subsystem may have boot, security, or power management subsystems. Second, the low-power subsystem may present a unique organization of local memory (LMEM) and shared memory (SMEM) to minimize power. Third, the low-power subsystem may have an access path to a backing store, e.g., DRAM, that can be used intermittently. Unlike typical SoCs, this access path is enabled without needing to boot the main CPUs or the full-stack OS. Fourth, the low-power subsystem may include one or more micro-controllers capable of running a real-time OS (RTOS) or a stripped down version of a full OS to support a small number of drivers. Fifth, the low-power subsystem may have the ability to run applications specifically designed to take advantage of the lower power. Sixth, the low-power subsystem may have the ability to detect situations when the full CPU and OS are needed and support fast transitions to the full SoC functionality.

In some example approaches, the SoC may include systems and subsystems that each incorporates SRAM distributed as a local memory. The local memory (LMEM) may be used as static memory (SMEM), cache or a combination of SMEM and cache. A portion of the local memory may also be allocated as virtual memory and used to store large data sets, reducing the use of off die Dynamic Random-Access Memory (DRAM). However, the low-power subsystem can access DRAM as needed to support dual ports of an application. That is, one port of the application is for execution by the low-power subsystem—with its own application stack—and one port of the application is for execution by the full system including main SoC CPU(s). The port of the application for execution by the low-power subsystem may have reduced functionality compared to the port of the application for the execution by the full system. The low-power subsystem has access to the DRAM and therefore performs DRAM management, i.e., without relying on the main SoC CPU(s) for DRAM management.

The techniques described herein may be implemented on an SoC that has multiple subsystems for performing various functions of the system. Examples of such subsystems include system control subsystems, communications subsystems, security subsystems, video processing subsystems, etc. Some of the subsystems may not need to be always powered on. For instance, a video subsystem need not be powered on if a camera on the system is not in use.

The techniques of this disclosure may provide one or more technical advantages. For example, the techniques allow execution of applications, provided a suitable port of the application, without requiring the higher-powered SoC components, such as the main SoC all-day wearable device. The SoC power required to run a full-stack SoC is one of the primary power consumers. The low power subsystem can provide the ability to run simple apps, such as music streaming, notifications, or always-on display, without needing the full operating system. Consequently, the techniques may reduce power consumption and extend the battery life of artificial reality devices.

In an example, a system on a chip (SoC) comprises SoC memory; one or more processor subsystems, wherein each processor subsystem includes a processor connected to the SoC memory; and a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem.

In an example, an artificial reality system comprises a display screen for a head-mounted display (HMD); and at least one system on a chip (SoC) connected to the HMD display screen and configured to output artificial reality content on the HMD display screen, wherein the at least one SoC comprises: SoC memory; one or more processor subsystems, wherein each processor subsystem includes a processor connected to the SoC memory; and a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem.

In an example, in an artificial reality system having a display screen for a head-mounted display (HMD) and at least one system on a chip (SoC) connected to the HMD display screen and configured to output artificial reality content on the HMD display screen, wherein the at least one SoC includes SoC memory, one or more compute subsystems connected to the SoC memory, and a low power subsystem connected to the SoC memory and to the compute subsystems, the low power subsystem including a microcontroller and a power management unit (PMU), the low power subsystem integrated as a separate subsystem in the SoC, a method comprising: executing one or more processes in a microcontroller of the low power subsystem, each process having a state, the microcontroller executing a first operating system; determining, in the microcontroller, whether one or more of the compute subsystems should be activated, the compute subsystems executing a second operating system different from the first operating system; if one or more of the compute subsystems should be activated, selecting one or more of the processes executing in the microcontroller, saving the state of the selected processes to SoC memory, activating the one or more compute subsystems via the PMU, transferring the state of the selected processes to the activated compute systems, and executing instructions in the activated compute subsystems to execute the selected processes based on the transferred state.

In an example, a system on a chip (SoC) comprises SoC memory; one or more processor subsystems, wherein each processor subsystem includes a processor connected to the SoC memory; and a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem, wherein the low power subsystem is configured to boot up the SoC via the microcontroller executing out of SoC memory.

In an example, an artificial reality system comprises a display screen for a head-mounted display (HMD); and at least one system on a chip (SoC) connected to the HMD display screen and configured to output artificial reality content on the HMD display screen, wherein the at least one SoC comprises: SoC memory; one or more processor subsystems, wherein each processor subsystem includes a processor connected to the SoC memory; and a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem, wherein the low power subsystem is configured to boot up the SoC via the microcontroller executing out of SoC memory.

In an example, in an artificial reality system having a display screen for a head-mounted display (HMD) and at least one system on a chip (SoC) connected to the HMD display screen and configured to output artificial reality content on the HMD display screen, wherein the at least one SoC includes SoC memory, one or more compute subsystems connected to the SoC memory, and a low power subsystem connected to the compute subsystems and the SoC memory, the low power subsystem integrated as a separate subsystem in the SoC, a method comprising: booting the artificial reality system into a low power compute state, wherein booting includes executing one or more processes in a microcontroller of the low power subsystem; determining, at the microcontroller, whether to move to one of the higher power compute states; and if moving to one of the higher power compute states: selecting one of the one or more compute subsystems, wherein selecting includes supplying power from the PMU to the selected compute subsystem; selecting one or more of the processes executing in the microcontroller of the low power subsystem, wherein selecting the processes includes saving the state of the selected processes to the SoC memory; executing the selected processes on the selected compute subsystem, wherein executing includes receiving the state of the selected processes at the selected compute subsystem and executing instructions in the selected compute subsystem to execute the selected processes in the selected compute subsystem based on the received state; determining, at one of the selected compute subsystems, whether to move to one of the lower power compute states; and if moving to one of the lower power compute states: selecting one of the one or more compute subsystems to be deactivated, wherein selecting includes saving, to the SoC memory, the state of the processes executing on the compute subsystem to be deactivated; configuring the PMU to deactivate the selected compute subsystem; and executing the selected processes on the microcontroller, wherein executing includes receiving the state of the selected processes at the microcontroller and executing instructions in the microcontroller to execute the selected processes in the microcontroller based on the received state.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is an illustration depicting an example artificial reality system that includes an SoC having compute elements and local memory, arranged in accordance with techniques described in this disclosure.

FIG. 2A is an illustration depicting an example HMD having compute elements and local memory shared by the compute elements, in accordance with techniques described in this disclosure.

FIG. 2B is an illustration depicting another example HMD that includes an SoC having compute elements and local memory shared by the compute elements, in accordance with techniques described in this disclosure.

FIG. 3 is a block diagram showing example implementations of a console and an HMD of the artificial reality system of FIG. 1, in accordance with techniques described in this disclosure.

FIG. 4 is a block diagram depicting one example HMD of the artificial reality system of FIG. 1, in accordance with the techniques described in this disclosure.

FIG. 5 is a block diagram illustrating an example implementation of a distributed architecture for a multi-device artificial reality system in which one or more devices are implemented using one or more SoCs within each device, in accordance with techniques described in this disclosure.

FIG. 6 is a block diagram illustrating an example power architecture in a multiprocessor system, in accordance with techniques described in this disclosure.

FIG. 7 is a block diagram illustrating an SoC with the power architecture of FIG. 6, in accordance with techniques described in this disclosure.

FIG. 8 is a block diagram illustrating an example of a Low Power Subsystem which may be implemented in the SOCs of FIGS. 1, 3-5 and 7, in accordance with techniques described in this disclosure.

FIG. 9 is a flowchart illustrating a method of moving between processor power states, in accordance with techniques described in this disclosure.

FIG. 10 is a flowchart illustrating a method of saving program state when moving between compute resources, in accordance with techniques described in this disclosure.

FIG. 11 is a flowchart illustrating another method of moving between processor power states, in accordance with techniques described in this disclosure.

FIG. 12 is a flowchart illustrating another method of saving program state when moving between compute resources, in accordance with techniques described in this disclosure.

FIG. 13 is a flowchart illustrating a power management technique in a system having the power architecture of FIG. 6, in accordance with techniques described in this disclosure.

FIG. 14 is a flowchart illustrating another power management technique in a system having the power architecture of FIG. 6, in accordance with techniques described in this disclosure.

### DETAILED DESCRIPTION

Electronic devices may operate in a low-power mode even when not being used, allowing them to respond almost instantly when activated. For example, an artificial reality system may be configured to operate in a reduced power state, maintaining as active only those sensors needed to detect movement, and using that movement detection to initiate a more active mode. It may be advantageous to reduce the energy needed to maintain the reduced power state. In one example approach, the energy needed to maintain a low-power state within an SoC is reduced by adding a low-latency, low-power, always-on subsystem to the SoC.

In one example approach, this may be accomplished by incorporating a “low-power island” (e.g., a miniSoC) within the SoC to create an SoC capable of operating in an ultra-low-power mode. Integration in this way facilitates integrated (faster, better) power management. In some such example approaches, the miniSoC performs various functions, e.g., secure boot, power management, sensor hub, fitness tracking, GPS chip, Bluetooth, some custom machine learning blocks, and basic SoC services normally performed by the SoC CPU.

In one example approach, an SoC includes one or more CPUs (operating as system or application processors), static random-access memory (SRAM), and access to external dynamic random-access memory (DRAM). The CPUs execute a full-fledged OS, which may be an OS developed for an artificial reality/extended reality system. The miniSoC, on the other hand, includes a microcontroller unit (MCU) with access to the SRAM used by the CPUs. In one example approach, the MCU runs a separate real-time operating system (RTOS) using only the SRAM, or a combination of the SRAM and the DRAM. Importantly, any processor or MCU may assume responsibility for executing an application; the CPUs and MCUs are configured to offload any memory state from any one class of processor to another class of processor. For example, an application processor of the main SoC running the full OS may “send” data to a microcontroller on the miniSoC that is running RTOS, and the miniSoC may subsequently assume the execution thread using the data sent.

In one example approach, each SoC includes a small low-power subsystem used to boot up the SoC, to initiate those activities that may be performed by the low-power subsystem, and to wake up the CPUs when necessary (i.e., for heavier workloads or for features that need full OS support (e.g., LTE). In some example approaches, the subsystem includes an MCU. The MCU provides secure boot, power management, a sensor hub, and basic monitoring and housekeeping SoC features. In some such example approaches, the low-power subsystem also manages sensor and dataflow pipelines to reduce response latency and to reduce power by limiting the active domains while managing the complex security of increased attack surface area during power transitions. The low-power subsystem may also be used in some situations to run “MCU-mode” use cases at a fraction of the power without waking the full power of the SoC.

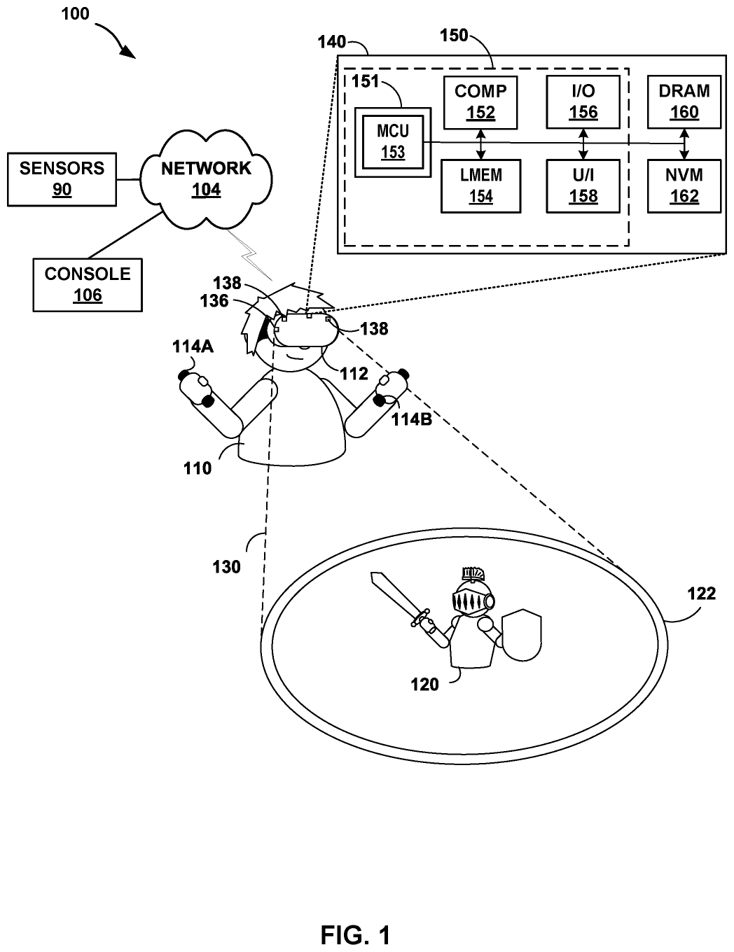

FIG. 1 is an illustration depicting an example artificial reality system that includes an SoC having compute elements and local memory, arranged in accordance with techniques described in this disclosure. The artificial reality system of FIG. 1 may be a virtual reality system, an augmented reality system, or a mixed reality system. In the example of FIG. 1, artificial reality system 100 includes a head mounted display (HMD) 112, one or more controllers 114A and 114B (collectively, “controller(s) 114”), and may in some examples include one or more external sensors 90 and/or a console 106.

HMD 112 is typically worn by user 110 and includes an electronic display and optical assembly for presenting artificial reality content 122 as virtual objects 120 to user 110. In addition, HMD 112 includes an internal control unit 140 and one or more sensors 136 (e.g., accelerometers) for tracking motion of the HMD 112. In one example approach, internal control unit 140 includes one or more SoCs, each SoC including two or more compute elements and memory that is distributed among specific compute elements but accessible to other compute elements. HMD 112 may further include one or more image capture devices 138 (e.g., cameras, line scanners) for capturing image data of the surrounding physical environment. Although illustrated as a head-mounted display, AR system 100 may alternatively, or additionally, include glasses or other display devices for presenting artificial reality content 122 to user 110. In some example approaches, internal control unit 140 includes a low power subsystem (LPSS 151) having a microcontroller unit (MCU) 153, as described in further detail below.

Each of controller(s) 114 is an input device that user 110 may use to provide input to console 106, HMD 112, or another component of AR system 100. Controller 114 may include one or more presence-sensitive surfaces for detecting user inputs by detecting a presence of one or more objects (e.g., fingers, stylus) touching or hovering over locations of the presence-sensitive surface. In some examples, controller(s) 114 may include an output display, which, in some examples, may be a presence-sensitive display. In some examples, controller(s) 114 may be a smartphone, tablet computer, personal data assistant (PDA), or other hand-held device. In some examples, controller(s) 114 may be a smartwatch, smart ring, or other wearable device. Controller(s) 114 may also be part of a kiosk or other stationary or mobile system. Alternatively, or additionally, controller(s) 114 may include other user input mechanisms, such as one or more buttons, triggers, joysticks, D-pads, or the like, to enable a user to interact with and/or control aspects of the artificial reality content 122 presented to user 110 by AR system 100.

In this example, console 106 is shown as a single computing device, such as a gaming console, workstation, a desktop computer, or a laptop. In other examples, console 106 may be distributed across a plurality of computing devices, such as a distributed computing network, a data center, or a cloud computing system. Console 106, HMD 112, and sensors 90 may, as shown in this example, be communicatively coupled via network 104, which may be a wired or wireless network, such as Wi-Fi, a mesh network or a short-range wireless communication medium, or combination thereof. Although HMD 112 is shown in this example as being in communication with, e.g., tethered to or in wireless communication with, console 106, in some implementations HMD 112 operates as a stand-alone, mobile AR system, and AR system 100 may omit console 106.

In general, AR system 100 renders artificial reality content 122 for display to user 110 at HMD 112. In the example of FIG. 1, a user 110 views the artificial reality content 122 constructed and rendered by an artificial reality application executing on compute elements within HMD 112 and/or console 106. In some examples, the artificial reality content 122 may be fully artificial, i.e., images not related to the environment in which user 110 is located. In some examples, artificial reality content 122 may comprise a mixture of real-world imagery (e.g., a hand of user 110, controller(s) 114, other environmental objects near user 110) and virtual objects 120 to produce mixed reality and/or augmented reality. In some examples, virtual content items may be mapped (e.g., pinned, locked, placed) to a particular position within artificial reality content 122, e.g., relative to real-world imagery. A position for a virtual content item may be fixed, as relative to one of a wall or the earth, for instance. A position for a virtual content item may be variable, as relative to controller(s) 114 or a user, for instance. In some examples, the particular position of a virtual content item within artificial reality content 122 is associated with a position within the real-world, physical environment (e.g., on a surface of a physical object).

During operation, the artificial reality application constructs artificial reality content 122 for display to user 110 by tracking and computing pose information for a frame of reference, typically a viewing perspective of HMD 112. Using HMD 112 as a frame of reference and based on a current field of view as determined by a current estimated pose of HMD 112, the artificial reality application renders 3D artificial reality content which, in some examples, may be overlaid, at least in part, upon the real-world, 3D physical environment of user 110. During this process, the artificial reality application uses sensed data received from HMD 112 and/or controllers 114, such as movement information and user commands, and, in some examples, data from any external sensors 90, such as external cameras, to capture 3D information within the real world, physical environment, such as motion by user 110 and/or feature tracking information with respect to user 110. Based on the sensed data, the artificial reality application determines a current pose for the frame of reference of HMD 112 and, in accordance with the current pose, renders the artificial reality content 122.

AR system 100 may trigger generation and rendering of virtual content items based on a current field of view 130 of user 110, as may be determined by real-time gaze tracking of the user, or other conditions. More specifically, image capture devices 138 of HMD 112 capture image data representative of objects in the real-world, physical environment that are within a field of view 130 of image capture devices 138. Field of view 130 typically corresponds with the viewing perspective of HMD 112. In some examples, the artificial reality application presents artificial reality content 122 comprising mixed reality and/or augmented reality. The artificial reality application may render images of real-world objects, such as the portions of a peripheral device, the hand, and/or the arm of the user 110, that are within field of view 130 along with virtual objects 120, such as within artificial reality content 122. In other examples, the artificial reality application may render virtual representations of the portions of a peripheral device, the hand, and/or the arm of the user 110 that are within field of view 130 (e.g., render real-world objects as virtual objects 120) within artificial reality content 122. In either example, user 110 can view the portions of their hand, arm, a peripheral device and/or any other real-world objects that are within field of view 130 within artificial reality content 122. In other examples, the artificial reality application may not render representations of the hand or arm of user 110.

To provide virtual content alone, or overlaid with real-world objects in a scene, HMD 112 may include a display system. For example, the display may include a projector and waveguide configured to translate the image output by the projector to a location viewable by a user's eye or eyes. The projector may include a display and a projector lens. The waveguide may include an input grating coupler to redirect light from the projector into the waveguide, and the waveguide may “trap” the light via total internal reflection (TIR). For example, the display may include arrays of red, green, and blue LEDs. In some examples, a color image may be formed by combination of the red, green, and blue light from each of the red, green, and blue LED arrays via a combiner. The waveguide may include an output grating to redirect light out of the waveguide, for example, towards an eye box. In some examples, the projector lens may collimate light from the display, e.g., the display may be located substantially at a focal point of the projector lens. The grating coupler may redirect the collimated light from the display into the waveguide, and the light may propagate within the waveguide via TIR at the surfaces of the waveguide. The waveguide may include an output structure, e.g., holes, bumps, dots, a holographic optical element (HOE), a diffractive optical element (DOE), etc., to redirect light from the waveguide to a user's eye, which focuses the collimated light from the display of the projector on the user's retina, thereby reconstructing the display image on the user's retina. In some examples, the TIR of the waveguide functions as a mirror and does not significantly affect the image quality of the display, e.g., the user's view of the display is equivalent to viewing the display in a mirror.

As further described herein, one or more devices of artificial reality system 100, such as HMD 112, controllers 114 and/or a console 106, may include SoCs. For instance, in the example shown in FIG. 1, internal control unit 140 includes an SCU 150. SoC 150 may include a low power subsystem 151, one or more compute elements 152, and on-die memory 154 collocated with the low power subsystem 151 and the compute elements 152.

In one example approach, internal control unit 140 includes an SoC 150 having two or more subsystems. Each subsystem includes compute elements 152 (processors or coprocessors) and corresponding local memory 154 (e.g., SRAM) collocated with the compute elements 152. In some such SoCs, portions of on-die SRAM are physically distributed throughout the SoC as Local Memory (LMEM) 154, with a different instance of LMEM 154 located close to each compute element 152. Such an approach allows for very wide, high bandwidth and low latency interfaces to the closest compute elements, while minimizing energy spent in communicating across long wires on the die. In some example approaches, SoC 150 also includes an input/output interface 156, a user interface 158, and a connection to one or more of external DRAM 160 and nonvolatile memory 162. In the example approach shown in FIG. 1, SoC 150 also includes a low power subsystem 151 integrated as a miniSoC within the SoC 150. Low power subsystem 151 includes MCU 153 connected to LMEM 154, volatile memory 160 and nonvolatile memory 162. In one example approach, MCU 153 executes a real time operating system.

In one example approach, each LMEM 154 may be configured as static memory (SMEM), cache memory, or a combination of SMEM and cache memory. In one such example approach, LMEM 154 includes SRAM. The SRAM may be configured as SMEM, cache memory, or a combination of SMEM and cache memory.

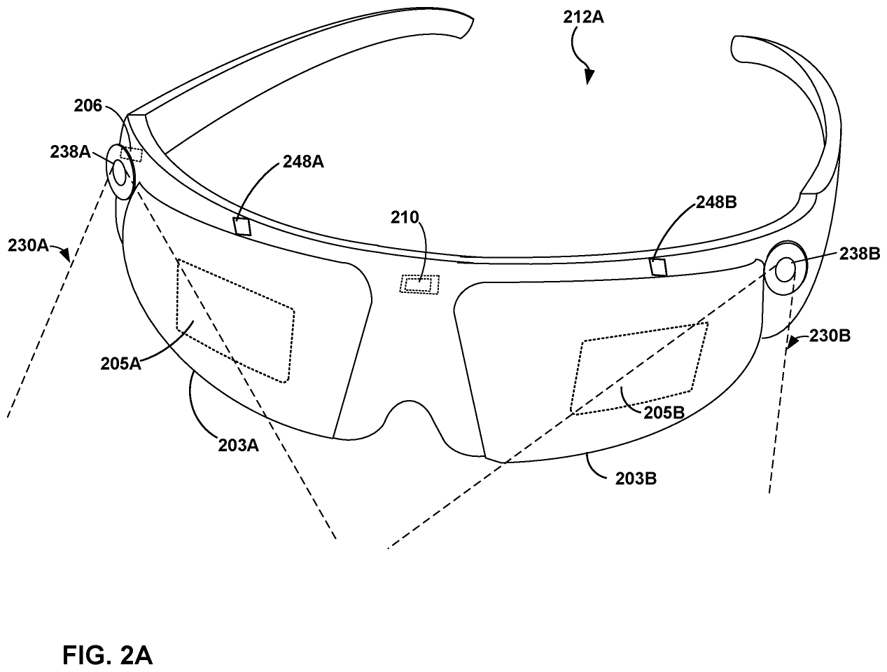

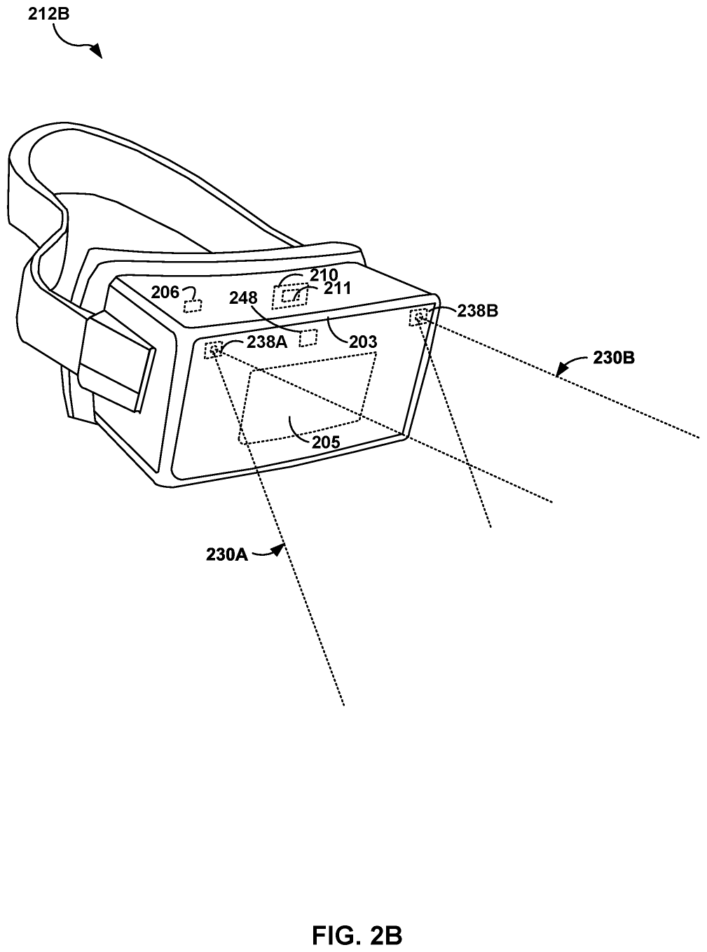

FIG. 2A is an illustration depicting an example HMD having compute elements and local memory shared by the compute elements, in accordance with techniques described in this disclosure. HMD 212A of FIG. 2A may be an example of HMD 112 of FIG. 1. As shown in FIG. 2A, HMD 212A may take the form of glasses. HMD 212A may be part of an artificial reality system, such as AR system 100 of FIG. 1, or may operate as a stand-alone, mobile artificial realty system configured to implement the techniques described herein.

In this example, HMD 212A are glasses comprising a front frame including a bridge to allow the HMD 212A to rest on a user's nose and temples (or “arms”) that extend over the user's ears to secure HMD 212A to the user. In addition, HMD 212A of FIG. 2A includes one or more projectors 248A and 248B, one or more waveguides 203A and 203B (collectively, “waveguides 203”) and one or more waveguide output structures 205A and 205B (collectively, “waveguide output structures 205”) configured to redirect light out of the waveguides 203A and 203B. In the example shown, projectors 248A and 248B (collectively, “projectors 248”) may input light, e.g., collimated light, into waveguides 203A and 203B via a grating coupler (not shown) that redirects light from the projectors 248 into waveguides 203 such that the light is “trapped” via total internal reflection (TIR) within the waveguide. For example, projectors 248A and 248B may include a display and a projector lens. In some examples, waveguides 203 may be transparent and alternatively may be referred to as “windows 203” hereinafter. In some examples, the known orientation and position of windows 203 relative to the front frame of HMD 212A is used as a frame of reference, also referred to as a local origin, when tracking the position and orientation of HMD 212A for rendering artificial reality content according to a current viewing perspective of HMD 212A and the user. In some examples, projectors 248 can provide a stereoscopic display for providing separate images to each eye of the user.

In the example shown, waveguide output structures 205 cover a portion of the windows 203, subtending a portion of the field of view 230 viewable by a user 110 through the windows 203. In other examples, the waveguide output structures 205 can cover other portions of the windows 203, or the entire area of the windows 203.

As further shown in FIG. 2A, in this example, HMD 212A further includes one or more motion sensors 206, one or more integrated image capture devices 238A and 238B (collectively, “image capture devices 238”), an internal control unit 210, which may include an internal power source and one or more printed-circuit boards having one or more processors, memory, and hardware to provide an operating environment for executing programmable operations to process sensed data and present artificial reality content on waveguide output structures 205. Internal control unit 210 may include an SoC in accordance with the present disclosure that receives information from one or more of sensor(s) 206, image capture devices 238, controller(s) such as controller(s) 114 as shown in FIG. 1, and/or other sensors, and that forms part of a computing system to process the sensed data and present artificial reality content on waveguide output structures 205 in accordance with the present disclosure. In one example approach, each SoC includes two or more compute elements and memory distributed among specific compute elements but accessible to other compute elements as detailed below. In some examples, the SoC of internal control unit 210 includes an LPSS 211 having a microcontroller unit (such as MCU 153) for low power operation of HMD 212A. In some such examples, LPSS 211 is a miniSoC integrated in the SoC.

Image capture devices 238A and 238B (collectively, “image capture devices 238”) may include devices such as video cameras, laser scanners, Doppler radar scanners, depth scanners, or the like, configured to output image data representative of the physical environment. More specifically, image capture devices 238 capture image data representative of objects in the physical environment that are within a field of view 230A, 230B of image capture devices 238, which typically corresponds with the viewing perspective of HMD 212A.

FIG. 2B is an illustration depicting another example HMD that includes an SoC having compute elements and local memory shared by the compute elements, in accordance with techniques described in this disclosure. HMD 212B may be part of an artificial reality system, such as artificial reality system 100 of FIG. 1, or may operate as a stand-alone, mobile artificial realty system configured to implement the techniques described herein.

In this example, HMD 212B includes a front rigid body and a band to secure HMD 212B to a user. In addition, HMD 212B includes a waveguide 203 (or, alternatively, a window 203) configured to present artificial reality content to the user via a waveguide output structure 205. In the example shown, projector 248 may input light, e.g., collimated light, into waveguide 203 via an input grating coupler (not shown) that redirects light from projector(s) 248 into waveguide 203 such that the light is “trapped” via total internal reflection (TIR) within waveguide 203. For example, projector 248 may include a display and a projector lens. In some examples, the known orientation and position of waveguide 203 relative to the front rigid body of HMD 212B is used as a frame of reference, also referred to as a local origin, when tracking the position and orientation of HMD 212B for rendering artificial reality content according to a current viewing perspective of HMD 212B and the user. In other examples, HMD 212B may take the form of other wearable head mounted displays, such as glasses or goggles.

Similar to HMD 212A of FIG. 2A, the example HMD 212B shown in FIG. 2B further includes one or more motion sensors 206, one or more integrated image capture devices 238A and 238B, an internal control unit 210, which may include an internal power source and one or more printed-circuit boards having one or more processors, memory, and hardware to provide an operating environment for executing programmable operations to process sensed data and present artificial reality content on waveguide output structure 205. Internal control unit 210 may include an SoC in accordance with the present disclosure that receives information from one or more of sensor(s) 206, image capture devices 238, controller(s) such as controller(s) 114 as shown in FIG. 1, and/or other sensors, and that forms part of a computing system to process the sensed data and present artificial reality content on waveguide output structures 205 in accordance with the present disclosure. In one example approach, each SoC includes two or more compute elements and memory distributed among specific compute elements but accessible to other compute elements as detailed below. In some examples, the SoC of internal control unit 210 includes an integrated miniSoC (such as LPSS 211) having a system microcontroller unit (SMCU) for low power operation of HMD 212A.

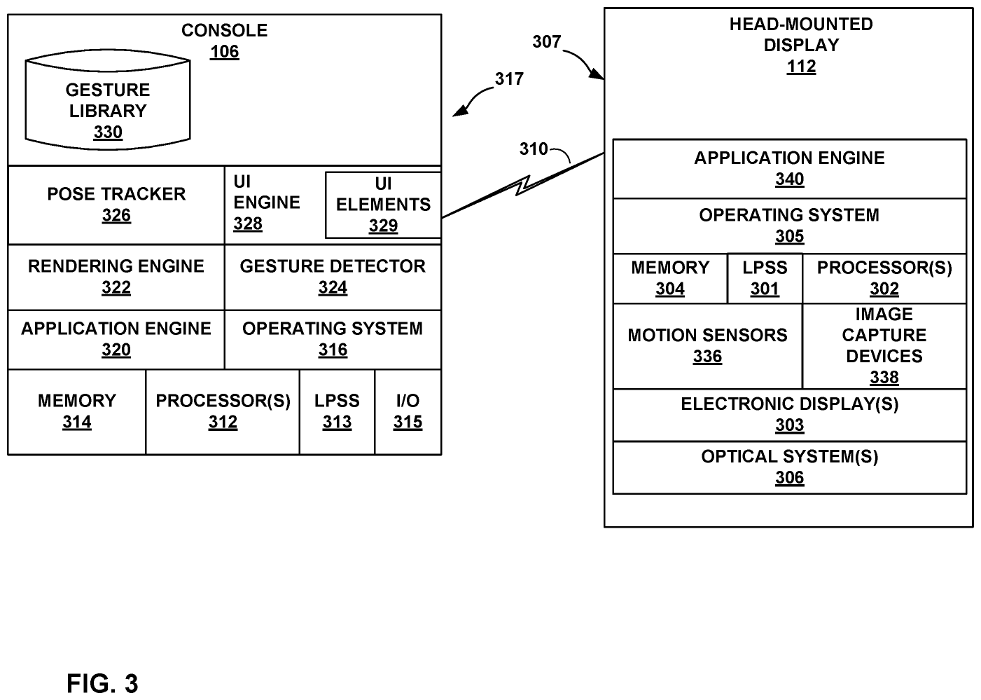

FIG. 3 is a block diagram showing example implementations of a console and an HMD of the artificial reality system of FIG. 1, in accordance with techniques described in this disclosure. In the example of FIG. 3, console 106 performs pose tracking, gesture detection, and user interface generation and rendering for HMD 112 based on sensed data, such as motion data and image data received from HMD 112 and/or external sensors.

In this example, HMD 112 includes one or more processors 302, LPSS 301 and memory 304 that together, in some examples, provide a computer platform for executing an operating system 305, which may be an embedded, real-time multitasking operating system, for instance, or other type of operating system. In some examples, operating system 305 provides a multitasking operating environment 307 for executing one or more software components, including application engine 340. In some such example approaches, an MCU in LPSS 301 executes a real-time operating system separate from the operating system used for processors 302. The separate operating system permits the MCU of LPSS 301 to execute in a low power mode while processor(s) 302 are asleep or otherwise disabled.

As discussed with respect to the examples of FIGS. 2A and 2B, processors 302 are coupled to one or more electronic displays 303, motion sensors 336, image capture devices 338, and, in some examples, optical system 306. Motion sensors 336 of FIG. 3 may be an example of motion sensors 206 of FIGS. 2A and 2B or of sensors 136 of FIG. 1. Image capture devices 338 of FIG. 3 may be an example of image capture devices 238 of FIGS. 2A and 2B or of image capture devices 138 of FIG. 1. In some examples, memory 304 includes local memory (such as the local memory 154 shown in FIG. 1) and one or more of volatile and nonvolatile memory (such as volatile memory 160 and nonvolatile memory 162 of FIG. 1, respectively).

In general, console 106 is a computing device that processes image and tracking information received from image capture devices 338 to perform gesture detection and user interface and/or virtual content generation for HMD 112. In some examples, console 106 is a single computing device, such as a workstation, a desktop computer, a laptop, or gaming system. In some examples, at least a portion of console 106, such as processors 312 and/or memory 314, may be distributed across a cloud computing system, a data center, or across a network, such as the Internet, another public or private communications network, for instance, broadband, cellular, Wi-Fi, and/or other types of communication networks for transmitting data between computing systems, servers, and computing devices.

In the example of FIG. 3, console 106 includes one or more processors 312, an LPSS 313 and memory 314 that, in some examples, provide a computer platform for executing an operating system 316, which may be an embedded, real-time multitasking operating system, for instance, or other type of operating system. In turn, operating system 316 provides a multitasking operating environment 317 for executing one or more software components. In some such example approaches, LPSS 313 executes a real-time operating system separate from the operating system used for processors 312. The separate operating system permits LPSS 313 to execute in a low power mode while processor(s) 312 are asleep or otherwise disabled.

In the example shown in FIG. 3, processors 312 are coupled to I/O interfaces 315, which include one or more I/O interfaces for communicating with external devices, such as a keyboard, game controller(s), display device(s), image capture device(s), HMD(s), peripheral device(s), and the like. Moreover, I/O interfaces 315 may include one or more wired or wireless network interface controllers (NICs) for communicating with a network, such as network 104 of FIG. 1. In some examples, functionality of processors 312, LPSS 313 and/or memory 314 for processing data may be implemented as an SoC/SRAM integrated circuit component in accordance with the present disclosure. In some examples, memory 314 includes local memory (such as the local memory 154 shown in FIG. 1) and one or more of volatile and nonvolatile memory (such as volatile memory 160 and nonvolatile memory 162 of FIG. 1, respectively).

Software components executing within multitasking operating environment 317 of console 106 operate to provide an overall artificial reality application. In this example, the software components include application engine 320, rendering engine 322, gesture detector 324, pose tracker 326, and user interface engine 328.

In some examples, processors 302 and memory 304 may be separate, discrete components (“off-die memory”). In other examples, memory 304 may be on-die memory collocated with processors 302 within a single integrated circuit such as an SoC (such as shown in FIG. 1). In some examples, functionality of processors 302 and/or memory 304 for processing data may be implemented as an SoC/SRAM integrated circuit component in accordance with the present disclosure. In addition, memories 304 and 314 may include both on-die and off-die memory, with at least portions of the on-die memory being used to cache data stored in the off-die memory.

In some examples, optical system 306 may include projectors and waveguides for presenting virtual content to a user, as described above with respect to FIGS. 2A and 2B. For example, optical system 306 may include a projector including electronic display 303 and a projection lens.

In general, application engine 320 includes functionality to provide and present an artificial reality application, e.g., a teleconference application, a gaming application, a navigation application, an educational application, training or simulation applications, and the like. Application engine 320 may include, for example, one or more software packages, software libraries, hardware drivers, and/or Application Program Interfaces (APIs) for implementing an artificial reality application on console 106. Responsive to control by application engine 320, rendering engine 322 generates 3D artificial reality content for display to the user by application engine 340 of HMD 112.

Application engine 320 and rendering engine 322 construct the artificial content for display to user 110 in accordance with current pose information for a frame of reference, typically a viewing perspective of HMD 112, as determined by pose tracker 326. Based on the current viewing perspective, rendering engine 322 constructs the 3D, artificial reality content which may in some cases be overlaid, at least in part, upon the real-world 3D environment of user 110. During this process, pose tracker 326 operates on sensed data received from HMD 112, such as movement information and user commands, and, in some examples, data from any external sensors 90 (FIG. 1), such as external cameras, to capture 3D information within the real-world environment, such as motion by user 110 and/or feature tracking information with respect to user 110. Based on the sensed data, pose tracker 326 determines a current pose for the frame of reference of HMD 112 and, in accordance with the current pose, constructs the artificial reality content for communication, via the one or more I/O interfaces 315, to HMD 112 for display to user 110.

Pose tracker 326 may determine a current pose for HMD 112 and, in accordance with the current pose, triggers certain functionality associated with any rendered virtual content (e.g., places a virtual content item onto a virtual surface, manipulates a virtual content item, generates and renders one or more virtual markings, generates and renders a laser pointer). In some examples, pose tracker 326 detects whether the HMD 112 is proximate to a physical position corresponding to a virtual surface (e.g., a virtual pinboard), to trigger rendering of virtual content.

User interface engine 328 is configured to generate virtual user interfaces for rendering in an artificial reality environment. User interface engine 328 generates a virtual user interface to include one or more virtual user interface elements 329, such as a virtual drawing interface, a selectable menu (e.g., drop-down menu), virtual buttons, a directional pad, a keyboard, or other user-selectable user interface elements, glyphs, display elements, content, user interface controls, and so forth.

Console 106 may output this virtual user interface and other artificial reality content, via a communication channel 310, to HMD 112 for display at HMD 112.

In one example approach, gesture detector 324 analyzes the tracked motions, configurations, positions, and/or orientations of controller(s) 114 and/or objects (e.g., hands, arms, wrists, fingers, palms, thumbs) of the user to identify one or more gestures performed by user 110, based on the sensed data from any of the image capture devices such as image capture devices 138, 238 or 338, from controller(s) 114, and/or from other sensor devices (such as motion sensors 136, 206 or 336). More specifically, gesture detector 324 analyzes objects recognized within image data captured by motion sensors 336 and image capture devices 338 of HMD 112 and/or sensors 90 to identify controller(s) 114 and/or a hand and/or arm of user 110, and track movements of controller(s) 114, hand, and/or arm relative to HMD 112 to identify gestures performed by user 110. In some examples, gesture detector 324 may track movement, including changes to position and orientation, of controller(s) 114, hand, digits, and/or arm based on the captured image data, and compare motion vectors of the objects to one or more entries in gesture library 330 to detect a gesture or combination of gestures performed by user 110. In some examples, gesture detector 324 may receive user inputs detected by presence-sensitive surface(s) of controller(s) 114 and process the user inputs to detect one or more gestures performed by user 110 with respect to controller(s) 114.

As noted above, in some examples, memories 304 and 314 may include on-die and off-die memory. In some such examples, portions of the on-die memory may be used as local memory for on-die compute elements and, occasionally, as cache memory used to cache data stored in other on-die memory or in off-die memory. For example, portions of memory 314 may be cached in local memory associated with processors 312 when the local memory is available for caching. In some examples, memory 304 includes local memory (such as the local memory 154 shown in FIG. 1) and one or more of volatile and nonvolatile memory (such as volatile memory 160 and nonvolatile memory 162 of FIG. 1, respectively).

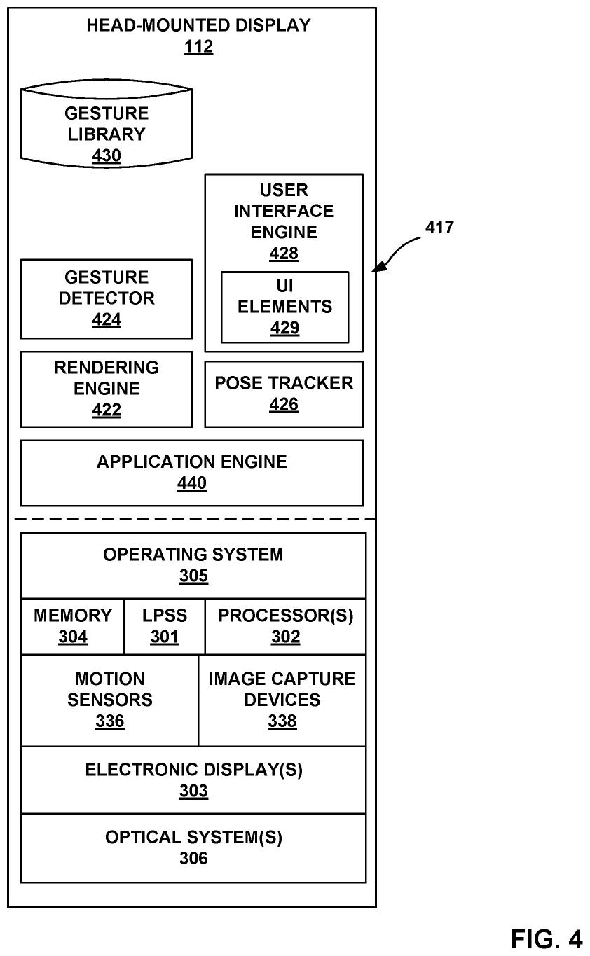

FIG. 4 is a block diagram depicting one example HMD of the artificial reality system of FIG. 1, in accordance with the techniques described in this disclosure. In the example shown in FIG. 4, HMD 112 is a standalone artificial reality system. In this example, like FIG. 3, HMD 112 includes one or more processors 302 and memory 304 that, in some examples, provide a computer platform for executing an operating system 305, which may be an embedded, real-time multitasking operating system, for instance, or other type of operating system. In turn, operating system 305 provides a multitasking operating environment for executing one or more software components 417. In some such example approaches, an MCU of LPSS 301 executes a real-time operating system separate from the operating system used for processors 302. The separate operating system permits the MCU of LPSS 301 to execute in a low power mode while processor(s) 302 are asleep or otherwise disabled.

Processor(s) 302 are also coupled to electronic display(s) 303, varifocal optical system(s) 306, motion sensors 336, and image capture devices 338. In some examples, functionality of processors 302 and/or memory 304 for processing data may be implemented as an SoC integrated circuit component in accordance with the present disclosure. In one such example approach, each SoC includes two or more compute elements and memory distributed as local memory among specific compute elements but accessible to each of the other compute elements via a local memory caching mechanism, as detailed below. In some examples, memory 304 includes local memory (such as the local memory 154 with integral VSMEM 155, as shown in FIG. 1) and one or more of volatile and nonvolatile memory (such as volatile memory 160 and nonvolatile memory 162 of FIG. 1, respectively).

In some examples, optical system 306 may include projectors and waveguides for presenting virtual content to a user, as described above with respect to FIGS. 2A and 2B. For example, optical system 306 may include a projector including electronic display 303 and a projection lens. The projection lens may further include a multi-functional DOE that functions as both a grating coupler to redirect light into a waveguide and as a lens element improving the imaging quality of the projector lens.

In the example of FIG. 4, software components 417 operate to provide an overall artificial reality application. In this example, software components 417 include application engine 440, rendering engine 422, gesture detector 424, pose tracker 426, and user interface engine 428. In various examples, software components 417 operate similar to the counterpart components of console 106 of FIG. 3 (e.g., application engine 320, rendering engine 322, gesture detector 324, pose tracker 326, and user interface engine 328) to construct virtual user interfaces overlaid on, or as part of, the artificial content for display to user 110.

As discussed with response to user interface engine 328 of FIG. 3, in one example approach, user interface engine 428 is configured to generate virtual user interfaces for rendering in an artificial reality environment. User interface engine 428 generates a virtual user interface to include one or more virtual user interface elements 429, such as a virtual drawing interface, a selectable menu (e.g., drop-down menu), virtual buttons, a directional pad, a keyboard, or other user-selectable user interface elements, glyphs, display elements, content, user interface controls, and so forth.

As in the console 106 of FIG. 3, in the example HMD 112 of FIG. 4, gesture detector 424 analyzes the tracked motions, configurations, positions, and/or orientations of controller(s) 114 and/or objects (e.g., hands, arms, wrists, fingers, palms, thumbs) of the user to identify one or more gestures performed by user 110, based on the sensed data from any of the image capture devices such as image capture devices 138, 238 or 338, from controller(s) 114, and/or from other sensor devices (such as motion sensors 136, 206 or 336). In some examples, gesture detector 424 may track movement, including changes to position and orientation, of controller(s) 114, hand, digits, and/or arm based on the captured image data, and compare motion vectors of the objects to one or more entries in gesture library 430 to detect a gesture or combination of gestures performed by user 110.

In some example approaches, memory 304 of FIG. 4 includes both on-die and off-die memory, with at least portions of the on-die memory being used to cache data stored in the off-die memory. In some examples, portions of memory 304 in FIG. 4 may be cached in local memory associated with processors 302 when the local memory is available for caching. Processors 302 may include one or more accelerators. In some examples, memory 304 includes local memory (such as the local memory 154 shown in FIG. 1) and one or more of volatile and nonvolatile memory (such as volatile memory 160 and nonvolatile memory 162, respectively, as shown in FIG. 1).

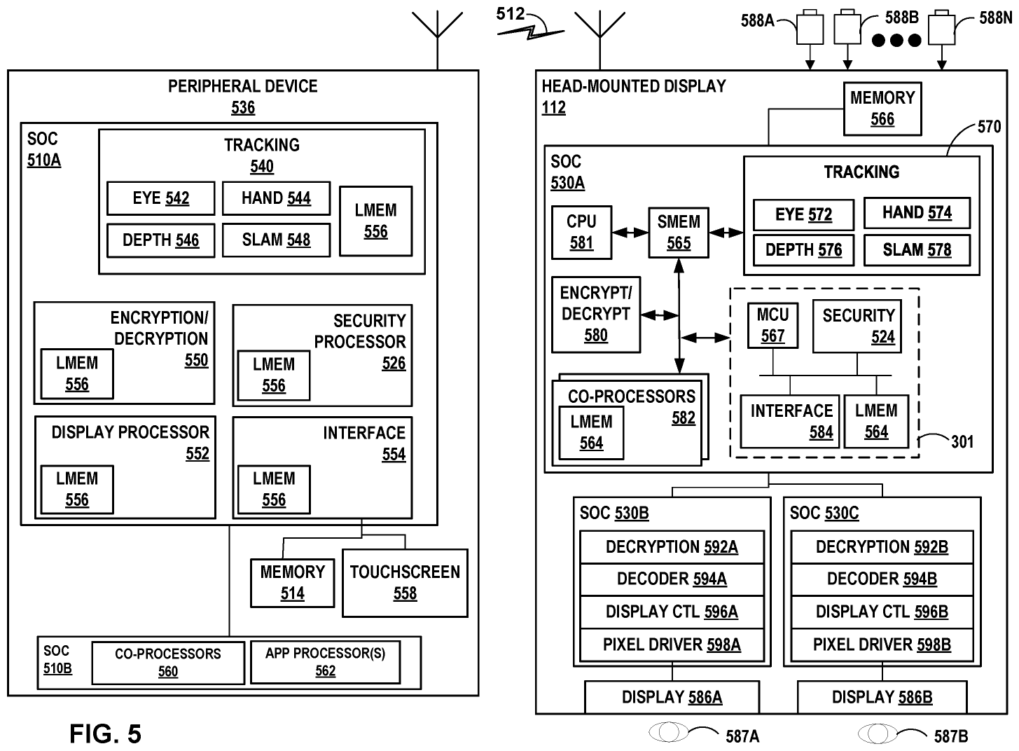

FIG. 5 is a block diagram illustrating an example implementation of a distributed architecture for a multi-device artificial reality system in which one or more devices are implemented using one or more SoCs within each device, in accordance with techniques described in this disclosure. FIG. 5 illustrates an example in which HMD 112 operates in conjunction with a peripheral device 536. As described above, HMD 112 is configured to operate with peripheral device 536 to enable the execution of artificial reality applications.

In the example of FIG. 5, peripheral device 536 represents a physical, real-world device having a surface on which multi-device artificial reality systems, such as systems 100, may overlay virtual content. Peripheral device 536 may include an interface 554 having one or more presence-sensitive surface(s) (such as touchscreen 558) for detecting user inputs by detecting a presence of one or more objects (e.g., a finger, a stylus, etc.) touching or hovering over locations of presence-sensitive surfaces. In some examples, peripheral device 536 may have a form factor similar to any of a smartphone, a tablet computer, a personal digital assistant (PDA), or other hand-held device. In other examples, peripheral device 536 may have the form factor of a smartwatch, a so-called “smart ring,” or other such wearable device. Peripheral device 536 may also be part of a kiosk, console, or other stationary or mobile system. Interface 554 may incorporate output components, such as touchscreen(s) 558, for outputting touch locations or other visual content to a screen. However, not all examples of peripheral device 536 include a display.

In the example of FIG. 5, HMD 112 and peripheral device 536 include SoCs 530A-530C and 510A-510B, respectively. SoCs 530A and 510A represent a collection of specialized integrated circuits arranged in a distributed architecture and configured to provide an operating environment for artificial reality applications. As examples, SoC integrated circuits may include a variety of compute elements. The compute elements may include specialized functional blocks operating as co-application processors, sensor aggregators, encryption/decryption engines, security processors, hand/eye/depth tracking and pose computation elements, video encoding and rendering engines, display controllers and communication control components. Some or all these functional blocks may be implemented as subsystems that include local memory such as LMEM 556 or 564. In one example approach, each SoC (510A, 510B, and 530A-530C) in FIG. 5 includes two or more compute elements, shared memory and memory distributed as local memory among specific compute elements but accessible to each of the other compute elements via a local memory caching mechanism, as detailed below. FIG. 5 is merely one example arrangement of SoC integrated circuits. The distributed architecture for a multi-device artificial reality system may include any collection and/or arrangement of SoC integrated circuits.

In the example of FIG. 5, HMD 112 includes SoCs 530A, 530B and 530C in accordance with the techniques of the present disclosure. In the example shown, SoC 530A includes local memories LMEM 564 which are, in some examples, SRAM but may be other types of memory. In some example approaches, LMEM 564 may be separated or external (e.g., not on-die) from the processor(s) and other on-die circuitry of SoC 530A. Peripheral device 536, in the current example, is implemented using a traditional SoC architecture, in which SoC 510A includes an on-die LMEM 556 that may be distributed across subsystems of SoC 510A, and external (off-die) memory 514, which may include volatile and/or non-volatile memory. In one example, HMD 112 includes a shared memory (SMEM) 565, which is on die, and a memory 566, which may include volatile and/or non-volatile memory, and which may be off die. In one example, portions of memory 566 may be cached in LMEM 564 when the various LMEM 564 are available for caching. Similarly, also in accordance with the techniques of the present disclosure, portions of memory 514 may be cached in LMEM 556 when the various LMEM 556 are available for caching.

In some examples, LMEM 564 includes local memory (such as the local memory 154 shown in FIG. 1, or the SMEM 565 or LMEM 564 of FIG. 5) connected to memory 566, with memory 566 including one or more of volatile and nonvolatile memory (such as volatile memory 160 and nonvolatile memory 162 of FIG. 1, respectively). In some examples, LMEM 556 includes local memory (such as the local memory 154 shown in FIG. 1) connected to memory 514, with memory 514 including one or more of volatile and nonvolatile memory (such as volatile memory 160 and nonvolatile memory 162 of FIG. 1, respectively).

Head-mounted displays, such as the HMD 112 described herein, benefit from the reduction in size, increased processing speed and reduced power consumption provided by using on-chip memory such as LMEM 564 in SoC 530A. For example, the benefits provided by the SoC 530A in accordance with the techniques of the present disclosure may result in increased comfort for the wearer and a more fully immersive and realistic AR/VR experience.

In addition, it shall be understood that any of SoCs 510 and/or 530 may be implemented using an SoC with integrated memory (i.e., LMEM or SMEM) in accordance with the techniques of the present disclosure, and that the disclosure is not limited in this respect. Any of the SoCs 510 and/or 530 may benefit from the reduced size, increased processing speed and reduced power consumption provided by the SoC/SRAM integrated circuit described herein. In addition, the benefits provided by the SoC/SRAM component in accordance with the techniques of the present disclosure are not only advantageous for AR/VR systems but may also be advantageous in many applications such as autonomous driving, edge-based artificial intelligence, the Internet-of-Things (IoT), and other applications which require highly responsive, real-time decision-making capabilities based on analysis of data from a large number of sensor inputs.

In the example of FIG. 5, SoC 530A of HMD 112 incorporates functional blocks including LPSS 301, a security processor 524, tracking 570, encryption/decryption 580, processors 581, co-processors 582, and an interface 584. In the example shown, security processor 524 and interface 584 are part of LPSS 301, where they share MCU 567 and LMEM 564. As noted above, in one example approach, LPSS 301 is a “low-power island” within SoC 530 that provides the capability to operate in an ultra-low-power mode. In some such example approaches, the LPSS 301 performs various functions, e.g., secure boot, power management, sensor hub, fitness tracking, GPS chip, Bluetooth, some custom machine learning blocks, and basic SoC services at a fraction of the power of a typical SoC CPU 582.

In one example approach, an SoC includes one or more CPUs (operating as system or application processors), static random-access memory (SRAM), and access to external dynamic random-access memory (DRAM). The CPUs execute a full-fledged OS. LPSS 301, on the other hand, includes a microcontroller unit (MCU 567) with access to the SRAM (LMEM 564 and SMEM 565) used by the CPUs. In one example approach, MCU 567 runs a separate real-time operating system (RTOS) using only the SRAM in LMEM 564 or SMEM 565, or a combination of the SRAM and the DRAM of memory 566. Importantly, any processor 581, co-processor 582 or MCU 567 may assume responsibility for executing an application; the CPUs, co-processors and MCUs are configured to offload any memory state from any one class of processor to another class of processor. For example, an application processor 581 of the main SoC running the full OS may “send” data to a microcontroller (i.e., MCU 567) on the LPSS 301 that is running RTOS, and the LPSS 301 may subsequently assume the execution thread using the data sent. In one example approach, an execution thread is transferred via a link to the state of the thread stored in LMEM 564 or SMEM 565.

In the example shown in FIG. 5, tracking 570 provides a functional block for eye tracking 572 (“eye 572”), hand tracking 574 (“hand 574”), depth tracking 576 (“depth 576”), and/or Simultaneous Localization and Mapping (SLAM) 578 (“SLAM 578”). Some or all these functional blocks may be implemented within one or more subsystems of SoC 530A. As an example of the operation of these functional blocks, HMD 112 may receive input from one or more accelerometers (also referred to as inertial measurement units or “IMUs”) that output data indicative of current acceleration of HMD 112, GPS sensors that output data indicative of a location of HMD 112, radar or sonar that output data indicative of distances of HMD 112 from various objects, or other sensors that provide indications of a location or orientation of HMD 112 or other objects within a physical environment. HMD 112 may also receive image data from one or more image capture devices 588A-588N (collectively, “image capture devices 588”). Image capture devices 588 may include video cameras, laser scanners, Doppler radar scanners, depth scanners, or the like, configured to output image data representative of the physical environment. More specifically, image capture devices 588 capture image data representative of objects (including peripheral device 536 and/or hand) in the physical environment that are within a field of view of image capture devices, which typically corresponds with the viewing perspective of HMD 112. Based on the sensed data and/or image data, tracking 570 determines, for example, a current pose for the frame of reference of HMD 112 and, in accordance with the current pose, renders the artificial reality content.

Encryption/decryption 580 of SoC 530A is a functional block to encrypt outgoing data communicated to peripheral device 536 or to a security server and decrypt incoming data communicated from peripheral device 536 or from a security server. Coprocessors 582 include one or more processors for executing instructions, such as a video processing unit, graphics processing unit, digital signal processors, encoders and/or decoders, and applications such as AR/VR applications.

Interface 584 of SoC 530A is a functional block that includes one or more interfaces for connecting to memory 566 and to functional blocks of SoC 530B and/or 530C. As one example, interface 584 may include peripheral component interconnect express (PCIe) slots. SoC 530A may connect with SoC 530B and 530C using interface 584. SoC 530A may also connect with a communication device (e.g., radio transmitter) using interface 584 for communicating via communications channel 512 with other devices, e.g., peripheral device 536.

SoCs 530B and 530C of HMD 112 each represents display controllers for outputting artificial reality content on respective displays, e.g., displays 586A, 586B (collectively, “displays 586”). In this example, SoC 530B may include a display controller for display 586A to output artificial reality content for a left eye 587A of a user. As shown in FIG. 5, SoC 530B may include a decryption block 592A, decoder block 594A, display controller 596A, and/or a pixel driver 598A for outputting artificial reality content on display 586A. Similarly, SoC 530C may include a display controller for display 586B to output artificial reality content for a right eye 587B of the user. As shown in FIG. 5, SoC 530C may include decryption 592B, decoder 594B, display controller 596B, and/or a pixel driver 598B for generating and outputting artificial reality content on display 586B. Displays 568 may include Light-Emitting Diode (LED) displays, Organic LEDs (OLEDs), Quantum dot LEDs (QLEDs), Electronic paper (E-ink) displays, Liquid Crystal Displays (LCDs), or other types of displays for displaying AR content.

As shown in FIG. 5, peripheral device 536 may include SoCs 510A and 510B configured to support an artificial reality application. In this example, SoC 510A comprises functional blocks including security processor 526, tracking 540, encryption/decryption 550, display processor 552, and interface 554. Tracking 540 is a functional block providing eye tracking 542 (“eye 542”), hand tracking 544 (“hand 544”), depth tracking 546 (“depth 546”), and/or Simultaneous Localization and Mapping (SLAM) 548 (“SLAM 548”). Some or all these functional blocks may be implemented in various subsystems of SoC 510A. As an example of the operation of SoC 510A, peripheral device 536 may receive input from one or more accelerometers (also referred to as inertial measurement units or “IMUs”) that output data indicative of current acceleration of peripheral device 536, GPS sensors that output data indicative of a location of peripheral device 536, radar or sonar that output data indicative of distances of peripheral device 536 from various objects, or other sensors that provide indications of a location or orientation of peripheral device 536 or other objects within a physical environment. Peripheral device 536 may in some examples also receive image data from one or more image capture devices, such as video cameras, laser scanners, Doppler radar scanners, depth scanners, or the like, configured to output image data representative of the physical environment. Based on the sensed data and/or image data, tracking block 540 determines, for example, a current pose for the frame of reference of peripheral device 536 and, in accordance with the current pose, renders the artificial reality content to HMD 112.

In another example approach, tracking block 570 determines the current pose based on the sensed data and/or image data for the frame of reference of peripheral device 536 and, in accordance with the current pose, renders the artificial reality content relative to the pose for display by HMD 112.

In one example approach, encryption/decryption 550 of SoC 510A encrypts outgoing data communicated to HMD 112 or security server and decrypts incoming data communicated from HMD 112 or security server. Encryption/decryption 550 may support symmetric key cryptography to encrypt/decrypt data using a session key (e.g., secret symmetric key). Display processor 552 of SoC 510A includes one or more processors such as a video processing unit, graphics processing unit, encoders and/or decoders, and/or others, for rendering artificial reality content to HMD 112. Interface 554 of SoC 510A includes one or more interfaces for connecting to functional blocks of SoC 510A. As one example, interface 584 may include peripheral component interconnect express (PCIe) slots. SoC 510A may connect with SoC 510B using interface 584. SoC 510A may connect with one or more communication devices (e.g., radio transmitter) using interface 584 for communicating with other devices, e.g., HMD 112.

SoC 510B of peripheral device 536 includes co-application processors 560 and application processors 562. In this example, co-processors 560 include various processors, such as a vision processing unit (VPU), a graphics processing unit (GPU), and/or central processing unit (CPU). Application processors 562 may execute one or more artificial reality applications to, for instance, generate and render artificial reality content and/or to detect and interpret gestures performed by a user with respect to peripheral device 536. In one example approach, both co-processors 560 and application processors 562 include on-chip memory (such as LMEM 556). Portions of memory 514 may be cached in LMEM 556 when the various LMEM 556 are available for caching.

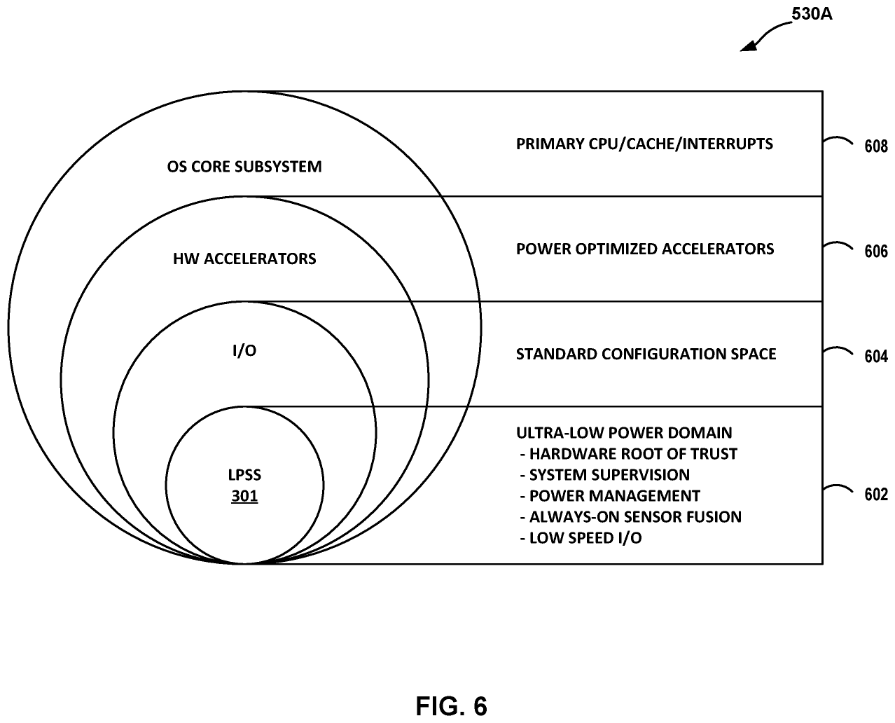

FIG. 6 is a block diagram illustrating an example power architecture in a multiprocessor system, in accordance with techniques described in this disclosure. As described above, it can be advantageous to provide different levels of processing power according to the needs of the system. In the example shown in FIG. 6, SOC 530A operates in one of four power domains: an ultra-low power domain 602, a standard I/O power domain 604, a hardware accelerator power domain 606, and a full power domain 608. In some example approaches, each power domain incorporates all or most of the lower power domains.

In one such example approach, a low power subsystem 301 provides a constrained level of processing power in the ultra-low power domain 602. In some examples, LPSS 301 provides limited services while monitoring a limited number of sensors. For example, LPSS 301 may enable and provide a minimal level of security services and limited, low-speed, I/O in the ultra-low power domain 602. At the standard I/O power domain 604, LPSS 301 may in addition, enable and provide higher speed I/O (such as USB, PCIe, SDIO and SPI with efficient DMIs).

In one example approach, when operating in ultra-low power domain 602, LPSS 301 provides services such as, for instance, hardware root of trust, system supervision, power management, and sensor fusion and low speed I/O. Execution continues in the ultra-low power domain 602 until the available processing power is insufficient to meet the processing needs, or until SOC 530A requires a form of I/O not provided in the ultra-low power level.

In the example shown in FIG. 6, LPSS 301 enables and provides additional processing power by enabling one or more hardware accelerators in a hardware accelerator power domain 606, or by providing more general computing power by enabling a CPU operating in a full power domain 608. In one example approach, accelerators 582 and CPUs 581 may be individually enabled or disabled within SOC 530A.

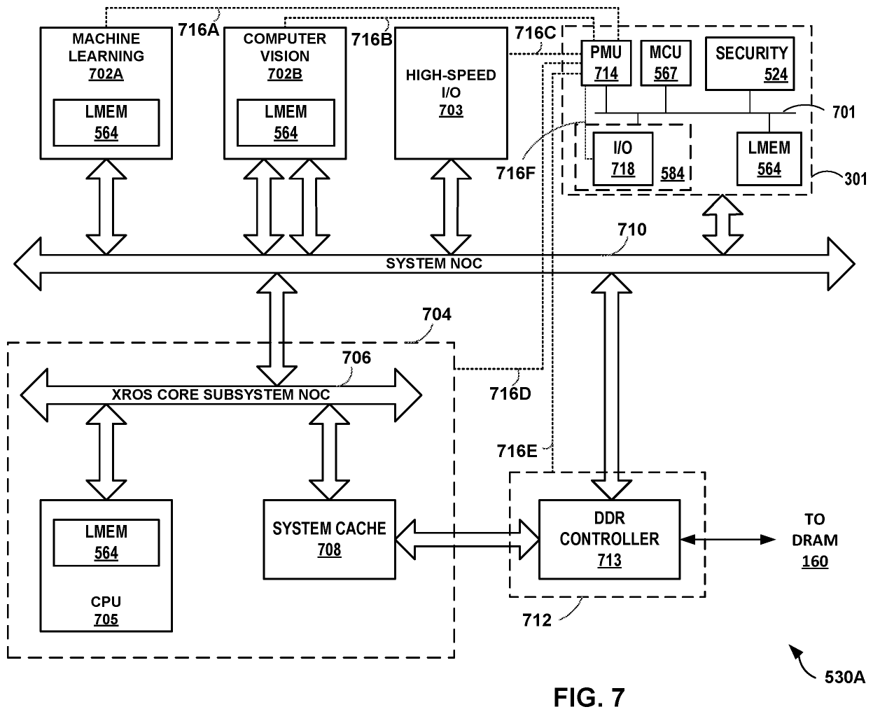

FIG. 7 is a block diagram illustrating an SoC with the power architecture of FIG. 6, in accordance with techniques described in this disclosure. In the example shown in FIG. 7, SOC 530A includes separately powered subsystems, including an LPSS 301. In the example shown, LPSS 301 includes an MCU 567 and a security processor 524 connected via an LPSS Network on Chip (NOC) 701 to an LMEM 564, and an interface 584. In the example shown in FIG. 7, interface 584 includes one or more I/O channels 718. In the example shown in FIG. 7, MCU 567 is also connected to power management unit (PMU) 714 and enables and disables individual subsystems within SOC 530A via PMU 714.

In the example of FIG. 7, SoC 530A includes a CPU power subsystem 704, two accelerators power subsystems 702A and 702B (collectively, accelerator power subsystems 702), a high-speed I/O power subsystem 703 and a DDR controller power subsystem 712, all under the control of PMU 714 of LPSS 301. In one example approach, a power subsystem enable 716A connects PMU 714 to machine learning accelerator power subsystem 702A and operates under control of MCU 567 to power up power subsystem 702A. A power subsystem enable 716B connects PMU 714 to computer vision accelerator power subsystem 702B and operates under control of MCU 567 to power up power subsystem 702B. A power subsystem enable 716C connects PMU 714 to high-speed I/O power subsystem 703 and operates under control of MCU 567 to power up high-speed I/O power subsystem 703. A power subsystem enable 716D connects PMU 714 to a CPU power subsystem 704 and operates under control of MCU 567 to power up CPU power subsystem 704. And a power subsystem enable 716E connects PMU 714 to a DDR controller power subsystem 712 and operates under control of MCU 567 to power up DDR controller power subsystem 712. And a local I/O enable 716F connects PMU 714 to I/O channels 718 and operates under control of MCU 567 to power up one or more interfaces of I/O channels 718.

In the example shown in FIG. 7, MCU 567 may be configured to enable a variety of power levels. MCU 567 may for instance, operate in a low power environment in which only LPSS 301 is active (e.g., the ultra-low power domain 602 of FIG. 6). In one such example approach, MCU 567 executes code written in local memory 564 of LPSS 301 and stores data in local memory 564 of LPSS 301. In another such example approach, MCU 567 includes storage for firmware executable at the lowest power level, storing data into the LMEM 564 of LPSS 301 as needed.

In one example approach, LPSS 301 includes interfaces (e.g., via interface 584) that are always on (e.g., the low speed I/O of the ultra-low power domain 602 of FIG. 6) and interfaces that are selectively enabled. In one such example approach, interfaces 584 includes interfaces 720 in I/O channels 718 that are always on and interfaces 722 in I/O channels 718 that are selectively enabled by MCU 567 (e.g., in the standard I/O power domain 604 of FIG. 6). In one such example approach, MCU 567 may enable one or more I/O channels in I/O channels 718 via local I/O enable 716F. Such an approach will selectively add an additional albeit small power load to the ultra-low power domain 602 of FIG. 6), moving SoC 530A into standard I/O power domain 604.

In one example approach, when additional memory is needed, MCU 567 gains access to DRAM 160 by configuring power subsystem enable 716E to power up DDR controller power subsystem 712. In some example approaches, the power load of enabling access to DRAM 160 may push SoC 530A into the standard I/O power domain 604 of FIG. 6. In one such example approach, code executing out of LMEM 564 of LPSS 301 may be downloaded from DRAM 160 by the DDR controller 713 of DDR controller power subsystem 712. In another such example approach, MCU 567 stores data in one or more of DRAM 160 or LMEM 564 of LPSS 301 and may retrieve data from one or more of DRAM 160 or LMEM 564 of LPSS 301. In yet another example approach, LMEM 564 of LPSS 301 is configured as virtual memory. In one such example approach, pages of virtual memory stored in LMEM 564 may be stored to and retrieved from DRAM 160 by the DDR controller 713 of DDR controller power subsystem 712.

In one example approach, SoC 530A enters hardware accelerator power domain 606 by enabling machine learning accelerator power subsystem 702A or by enabling computer vision accelerator power subsystem 702B. In one such example approach, SoC 530A enters full power domain 608 by enabling CPU power subsystem 704 and one or more of machine learning accelerator power subsystem 702A and computer vision accelerator power subsystem 702B.

In another example approach, SoC 530A may use power subsystem enable 716D to enable CPU power subsystem 704 while keeping the hardware accelerator power subsystems quiescent. Such an approach may be used, for instance, to provide more processor power in the absence of a need for, or as an alternative to, hardware acceleration.

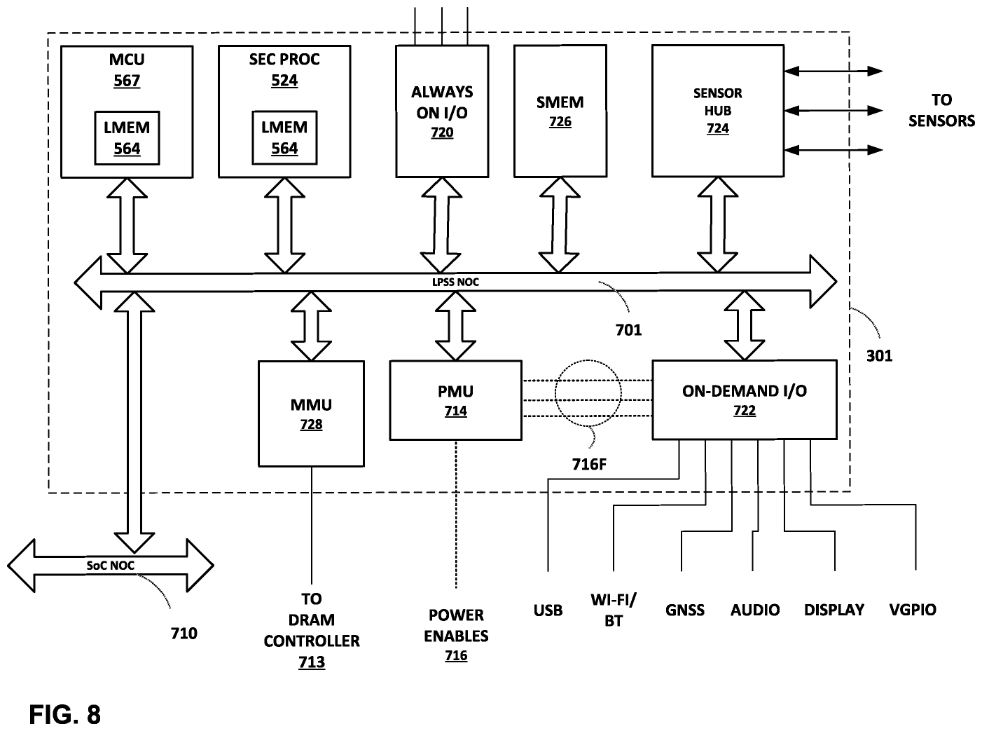

FIG. 8 is a block diagram illustrating an example of a Low Power Subsystem which may be implemented in the SOCs of FIGS. 1, 3-5 and 7, in accordance with techniques described in this disclosure. In the example shown in FIG. 8, LPSS 301 includes an MCU 567 having LMEM 564. MCU 567 and LMEM 564 are configured to store data and program code to be used by MCU 567 in LMEM 564. In some example approaches, MCU 567 is also connected through an LPSS Network on Chip (NOC) 701 to SMEM 726. SMEM 726 may in some examples, be Static Random-Access Memory (SRAM).

In the example shown in FIG. 8, MCU 567 is also connected through LPSS NOC 701 to Memory Management Unit (MMU) 728 and through MMU 728 to DRAM Controller 713. In one example approach, MCU 567 uses MMU 728 to transfer blocks of data between LMEM 564 and external DRAM 160 and to transfer blocks of data between SMEM 726 and external DRAM 160.

In one example approach, LPSS 301 includes a security processor 524 having LMEM 564. In the example shown in FIG. 8, security processor 524 is also connected through LPSS NOC 701 to Memory Management Unit (MMU) 728 and through MMU 728 to DRAM Controller 712. In one example approach, security processor 524 uses MMU 728 to transfer blocks of data between LMEM 564 and external DRAM 160 and to transfer blocks of data between SMEM 726 and external DRAM 160.

In the example shown in FIG. 8, MCU 567 and security processor 524 may communicate with CPU 705, machine learning accelerator 702A and computer vision accelerator 702B via System NOC 710, as shown in FIG. 7. In addition, MCU 567 and security processor 524 may communicate with high-speed I/O 703 via System NOC 710, also as shown in FIG. 7.

In some examples, MMU 728 is shared by LPSS 301 and other subsystems (e.g., CPU-based subsystems 704) and therefore allow address translation to be bypassed in order that memory accesses can go to DRAM controller 713 directly into DRAM 160. MMU 728 may support switching between address translation mode and bypass mode. The full stack operating system uses virtual address mapping and therefore requires address translation, but LPSS 301 may use its own address mapping and DRAM management to bypass MMU 728 in low-power mode, at least in some cases while sharing the same application data for applications running on the full OS. In some examples, SoC 530A may partition the physical memory address space of DRAM 160 so that LPSS 301 can map directly into a dedicated portion of the physical memory address space of DRAM 160 while other portions of DRAM 160 can be used for virtual addressing. In some examples, MMU 728 tables can be modified to support use by the LPSS 301 mapping and the standard virtual address mapping by other sub-systems of SoC 530A. In this way, SoC 530A provides the ability to transition between virtual and physical addressing based on whether the main operating system is booted.

In one example approach, LPSS 301 includes I/O 802 that are always on (e.g., the low speed I/O of the ultra-low power domain 602 of FIG. 6) and includes on-demand I/O 722 that are selectively enabled by MCU 567 or security processor 524 (e.g., in the standard I/O power domain 604 of FIG. 6). In one such example approach, MCU 567 may enable one or more I/O channels in on-demand I/O 722 via local I/O enable 716C. Such an approach will selectively add an additional albeit small power load to the ultra-low power domain 602 of FIG. 6). In another such example approach, security processor 524 may enable one or more I/O channels in on-demand I/O 722 via local I/O enable 716C. Such an approach will selectively add an additional albeit small power load to the ultra-low power domain 602 of FIG. 6.

In some example approaches, as illustrated in FIG. 8, LPSS 800 also includes a security processor 524. In some example approaches, security processor 524 provides secure device attestation and mutual authentication of HMD 112 when pairing with devices, e.g., console 106, used in conjunction within the AR environment. Security processor 524 may also authenticate SoCs 530A-530C of HMD 112 and may in some examples, authenticate SoCs 510A-510C of peripheral device 536. In some example approaches, security processor 524 also authenticates users, verifies files are not modified or corrupted, and provides a sandbox for secure execution of unverified program code. Examples of security processors are included in US patent Application No. 2021/0149824, filed Nov. 25, 2019, the descriptions of which are incorporated by reference.

As noted above, in one example approach, LPSS 301 is a “low-power island” which may be implemented as a miniSoC that is integrated within the main SoC. As shown in the example of FIG. 5, LPSS 301 may be integrated into SoC 530A. LPSS 301 may also be used advantageously, however, as part of SoC 510A. Integration in this way facilitates integrated (faster, better) power management. The miniSoC of LPSS 301 may perform various functions, e.g., secure boot, power management, sensor hub, fitness tracking, GPS chip, Bluetooth, some custom machine learning blocks, and basic SoC services.

In one example approach, SoC 530A includes LPSS 301 and one or more CPUs 581 (application processors) connected to SRAM 726. SoC 530A also includes an interface configured to communicate with memory 566 which, in some examples, includes DRAM. SoC 530A may execute a full-fledged OS, while the LPSS 301 includes a microcontroller 567 having access to the SRAM of LMEM 564 but which runs a separate real-time operating system using only the SRAM of LMEM 564—optionally without accessing memory 566.

In one example approach, CPUs 581 and application processors 582 are in a first class of processors, while MCU 567 is in a second class of processors. Each processor (CPU 581, application processor 582 and MCU 567) includes the ability to offload memory from one class of processor to another class of processor. For instance, CPU 581 may determine that the current processing tasks may be performed more efficiently on MCU 567 and swap out CPU 581 for MCU 567. In one example approach, a CPU 581 of the main SoC 530A running the full OS may “send” data to a microcontroller 567 on the miniSoC 301 that is running RTOS, and the miniSoC 301 may resume the execution thread using the data. In another example approach, an application processor 582 of the main SoC 530A running the full OS may “send” data to a microcontroller 567 on the miniSoC 301 that is running RTOS, and the miniSoC 301 may resume the execution thread using the data. In yet another example approach, a microcontroller 567 on the miniSoC 301 that is running RTOS may “send” data to a CPU 581 of the main SoC 530A running the full OS, and the CPU 581 may resume the execution thread using the data. In yet another example approach, a microcontroller 567 on the miniSoC 301 that is running RTOS may “send” data to an application processor 582 of the main SoC 530A running the full OS, and the application processor 582 may resume the execution thread using the data. In some example approaches, the state is stored in SRAM and the microcontroller send pointers to the state of processes executing in the microcontroller. Similarly, when transferring execution from a CPU 581 to microcontroller, the state is stored in SRAM and CPU 581 sends pointers to the state of processes executing in CPU 581.

In the example approach described herein, an SoC 510 or 530 includes one or more CPUs 581, one or more application processors 582, and memory 565 such as SRAM and, in some examples, memory 566 such as DRAM. The CPUs 581 execute a full-fledged OS. In one such example approaches, the miniSoC includes a microcontroller 567 having access to the SRAM of LMEM 564 and SMEM 565; the microcontroller 567 of the miniSoC runs a separate real-time operating system using only the SRAM—optionally without accessing the DRAM of memory 566. Importantly, any CPU 581 or microcontroller 567 may assume responsibility for executing an application; each CPU 581 and microcontroller 567 includes the ability to offload any memory from one class of processor to another class of processor. For example, an application processor of the main SoC running the full OS can “send” data to a microcontroller on the miniSoC that is running RTOS, and the miniSoC can assume the execution thread using the data, and vice versa.

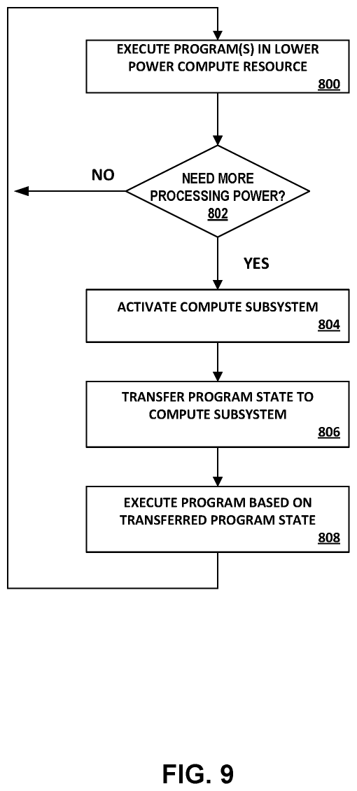

FIG. 9 is a flowchart illustrating a method of moving between processor power states, in accordance with techniques described in this disclosure. In one example approach, a lower-power compute resource executes programs in a low-power state (800). The lower-power compute resource may for example, be a microcontroller executing out of SRAM.

In one such example approach, the lower-power compute resource executes only a limited number of functions, e.g., secure boot, power management, sensor hub, fitness tracking, GPS chip, Bluetooth, custom machine learning blocks, and basic SoC services. The lower-power compute resource may be, for instance, a microcontroller. Other, more processor intensive tasks are performed in a compute subsystem. Some representative compute subsystems are CPU-based subsystems 704 and hardware accelerator subsystems 702 such as accelerators for machine learning (702A) and accelerators for computer vision (702B).

The lower-power compute resource periodically tests whether additional computing resources are needed (802) and, if not, continues to execute programs in the low-power state (800). In one example approach, the need for additional computing resources may be based on available processing cycles in the active compute resource(s). In another example approach, the need for additional computing resources may be a function of the programs initiated. For instance, a transition may happen automatically when certain programs are initiated. For example, when a computer vision program is initiated, accelerator power subsystem 702B may be activated. Similarly, when a machine learning program is initiated, accelerator power subsystem 702A may be activated. Furthermore, when one or more compute subsystems are activated, power management may be transferred to a CPU 705.

If additional computing resources are needed at 802, the lower-power compute resource activates a compute subsystem (804). Once activated, the lower-power compute resource stores the program state of programs to be transferred to the compute subsystem to memory and transfers the program state of the programs to the compute subsystem (806). The compute subsystem executes the transferred programs based on the transferred program state (808).

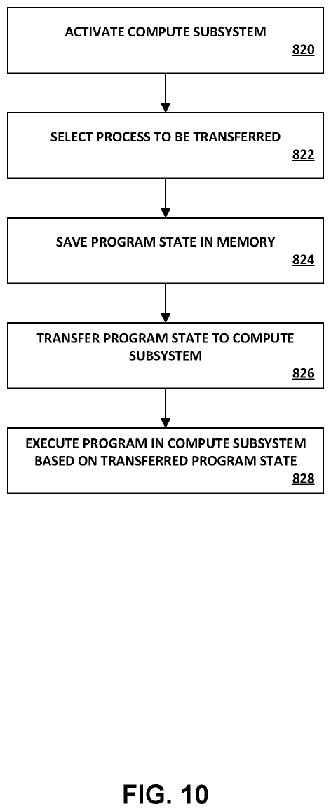

FIG. 10 is a flowchart illustrating a method of saving program state when moving between compute resources, in accordance with techniques described in this disclosure. In the example shown in FIG. 10, a lower-power compute resource activates a compute subsystem (820). The lower-power compute resource selects one or more processes to be transferred to the compute subsystem (822), saves the state of the programs to be transferred to memory (824), and transfers the state of the programs to be transferred to the compute subsystem (826). The compute subsystem then executes the transferred programs based on the transferred program state (828).

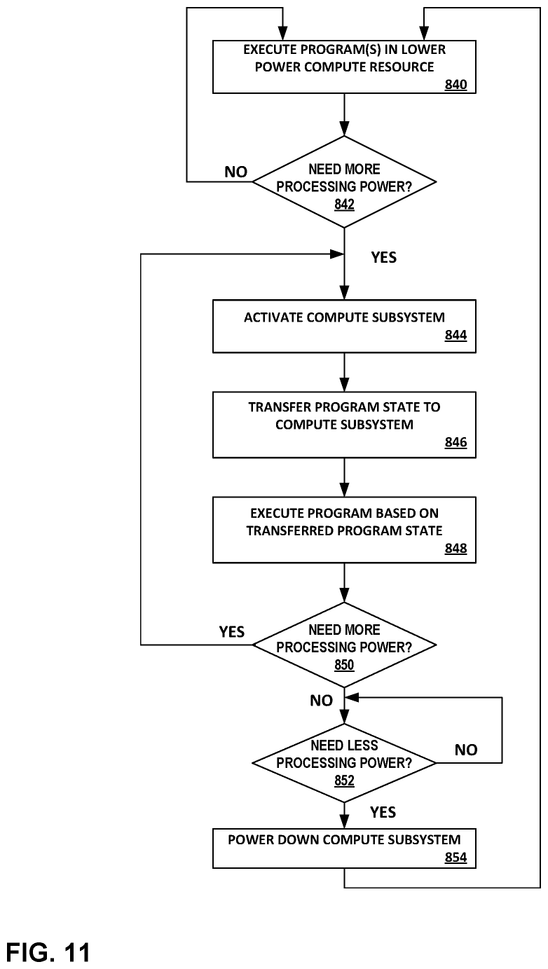

FIG. 11 is a flowchart illustrating another method of moving between processor power states, in accordance with techniques described in this disclosure. In one example approach, a lower-power compute resource executes programs in a low-power state (840). The lower-power compute resource may for example, be a microcontroller executing out of SRAM.

The lower-power compute resource periodically tests whether additional computing resources are needed (842) and, if not, continues to execute programs in the low-power state (840). If, however, additional computing resources are needed at 842 the lower-power compute resource activates a compute subsystem (844). Once activated, the lower-power compute resource stores the program state of programs to be transferred to the compute subsystem to memory and transfers the program state of the programs to the compute subsystem (846). The compute subsystem executes the transferred programs based on the transferred program state (848).

In one example approach, the lower-power compute resource continues to decide whether to bring additional compute subsystems online. In another example approach, one of the compute subsystems, such as a compute subsystem including a CPU, takes over monitoring for the need to add or subtract additional compute resources. In either approach, a check in made at (850) to determine whether additional computing resources are needed (842) and, if not, a check is made at (852) to see if less processing power is needed.

If a check at (850) determines additional compute resources are needed, another compute subsystem is activated (844), program state is transferred to the new compute subsystem (846) and the new compute subsystem executes the transferred programs based on the transferred program state (848).

If a check at (852) determines less compute resources are needed, one or more compute subsystems is deactivated. The program state of programs executing on the deactivated compute subsystems are then transferred to the lower-power compute resource or to one of the remaining compute subsystems, and the transferred programs are then executed based on the transferred program state (854).

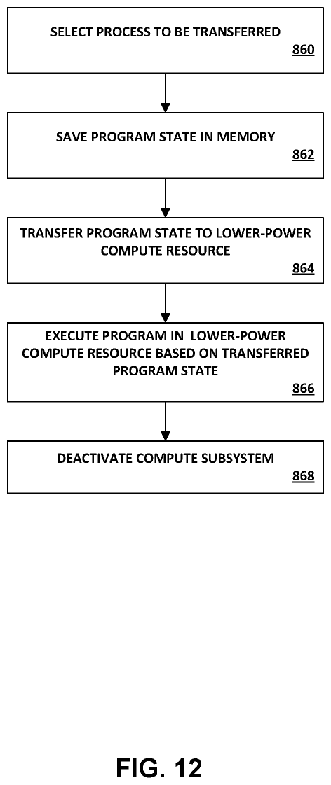

FIG. 12 is a flowchart illustrating another method of saving program state when moving between compute resources, in accordance with techniques described in this disclosure. In some example approaches, one of the compute subsystems activated by the lower-power compute resource assumes power management when activated and relinquishes such control when deactivated. In the example shown in FIG. 12, one of the compute subsystems selects one or more processes to be transferred to the lower-power compute resource (860) and saves the state of the programs to be transferred (862). In one such example, program state is stored in local memory. The states of the programs to be transferred are transferred to the lower-power compute resource (864). the lower-power compute resource then executes the transferred programs based on the transferred program state (866), before assuming control of power management and deactivating the compute subsystem (868).

MCU 567 may in some example approaches, boot up into an LPSS-only configuration that performs various functions only out of SMEM 726, e.g., secure boot, power management, sensor hub, fitness tracking, GPS chip, Bluetooth, custom machine learning blocks, and basic SoC services. When MCU 567 can no longer execute out of SMEM 726 alone, MCU 567 determines if it should execute out of a combination of SMEM and DRAM using its integrated MMU, or powers up one of the SoC CPUs 581 or application processors 582.

In one example approach, if the decision is to bring up one or more applications executing on MCU 567 in one or more of the SoC CPUs 581, the transition is simplified by providing access by the CPU 581 to the memory space being used by the MCU 567 to execute the application. If, on the other hand, the decision is to bring up one or more applications executing on MCU 567 in one or more of the SoC application processors 582, the transition is simplified by providing access by the application processors 582 to the memory space being used by the MCU 567 to execute the application.

In one approach, although the MCU 567 handles secure boot and the transition to using CPUs 581 and application processors 582, any CPU 581, application processor 582 or MCU 567 may afterwards assume responsibility for executing an application. For example, an application processor 582 of the main SoC running the full OS can “send” data to a microcontroller 567 on the miniSoC 301 that is running RTOS, and the miniSoC 301 may resume the execution thread using the data in its current location in SMEM 726, memory 566 or a combination of SMEM 726 and memory 566.

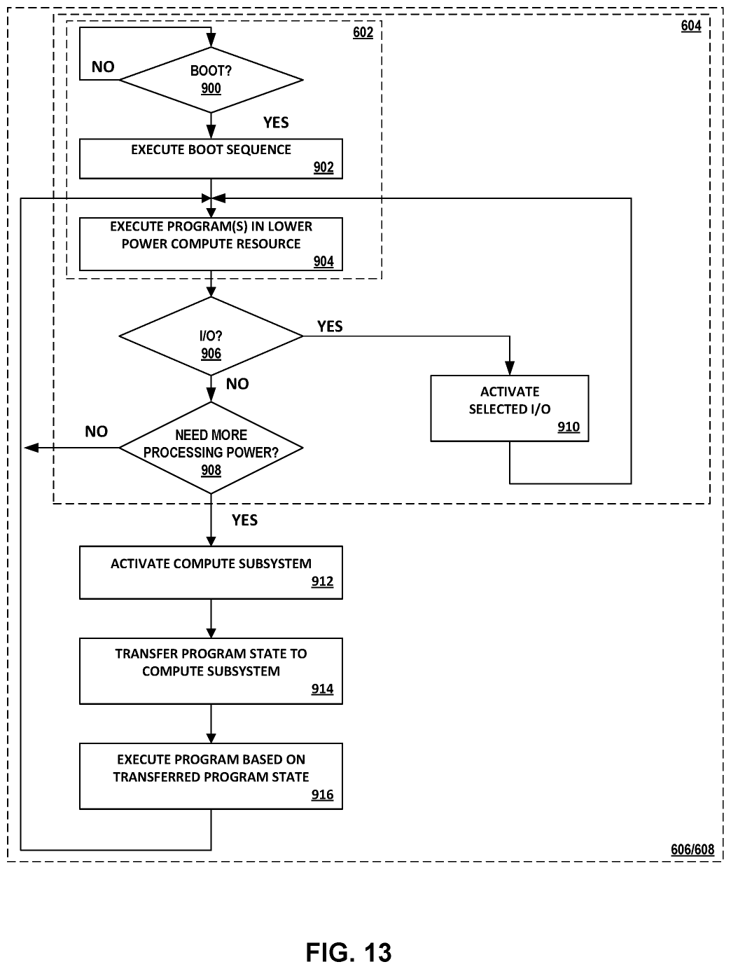

FIG. 13 is a flowchart illustrating a power management technique in a system having the power architecture of FIG. 6, in accordance with techniques described in this disclosure. In one example approach, a lower-power compute resource executes in the ultra-low power domain 602 of FIG. 6 while waiting for boot. The lower-power compute resource executes a boot sequence (902) in domain 602 on detecting boot (900) and then continues to execute programs in domain 602 (904). The lower-power compute resource may for example, be a microcontroller executing out of SRAM.

The lower-power compute resource periodically tests whether additional I/O resources are needed (906) and, if not, tests whether additional computing resources are needed (908). If neither is true, the SoC 530A continues to execute programs in lower-power compute resource 301 in the ultra-low power domain (904). If, however, additional I/O resources are needed at 906 the lower-power compute resource activates one or more I/O channels 718 in interface 584 (910), moving to the standard I/O power domain 604 of FIG. 6, while still executing programs in ultra-low power domain 602 via the lower-power compute resource (904).

If additional computing resources are needed at 908 the lower-power compute resource activates a compute subsystem (912), moving to the hardware accelerator power domain 606 or the full power domain 608 of FIG. 6. In one example approach, an additional compute subsystem in the form of a hardware accelerator may be desirable when executing machine learning or computer vision applications as shown in FIG. 7. In another example approach, a compute subsystem in the form of a CPU may be desirable when the microcontroller becomes too burdened, or when a high level of processing (e.g., operating out of virtual memory, or managing full operation) is needed. In one example approach, SoC 530A enters a power domain between standard I/O and full when only a few compute subsystems are active, no matter if they are CPUs or hardware accelerators and full power domain 606 is only entered when a pre-defined number of compute subsystems are active.

Once activated, the lower-power compute resource stores the program state of programs to be transferred to the compute subsystem to memory and transfers the program state of the programs to the compute subsystem (914). The compute subsystem then executes the transferred programs based on the transferred program state (916).

In one example approach, the lower-power compute resource continues to decide whether to bring additional compute subsystems online even if one or more compute subsystems are online. In another example approach, one of the compute subsystems, such as a compute power subsystem 704 having a CPU 705, takes over monitoring for the need to add or subtract additional compute resources.

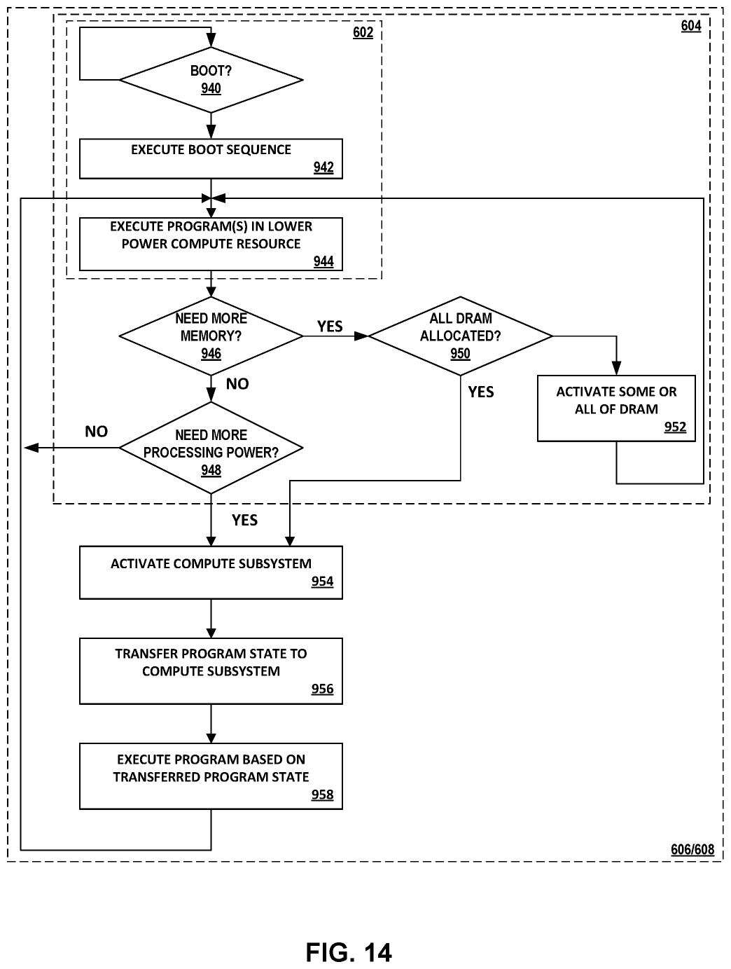

FIG. 14 is a flowchart illustrating another power management technique in a system having the power architecture of FIG. 6, in accordance with techniques described in this disclosure. In one example approach, a lower-power compute resource executes in the ultra-low power domain 602 of FIG. 6 while waiting for boot. The lower-power compute resource executes a boot sequence (942) in domain 602 on detecting boot (940) and then continues to execute programs in domain 602 (944). The lower-power compute resource may for example, be a microcontroller executing out of SRAM.

The lower-power compute resource periodically tests whether additional external memory (beyond SRAM) is needed (946) and, if not, tests whether additional computing resources are needed (948). If neither is true, the SoC 530A continues to execute programs in lower-power compute resource 301 in the ultra-low power domain (944). If, however, additional external memory (such as DRAM) is needed at 906, the lower-power compute resource checks if all external memory has been allocated (950), indicating that no additional DRAM is available. If so, more sophisticated memory management is needed and a compute subsystem having a CPU is activated (954). If, however, additional DRAM may be allocated, one or more DRAM subsystems is activated (952). The lower-power compute resource then stores data in both SRAM and DRAM, while still executing programs in ultra-low power domain 602 via the lower-power compute resource (904).

If additional computing resources are needed at 948 the lower-power compute resource activates a compute subsystem (954), moving to the hardware accelerator power domain 606 or the full power domain 608 of FIG. 6. In one example approach, SoC 530A enters a power domain between standard I/O 604 and full power domain 608 when only a few compute subsystems are active, not matter if they are CPUs or hardware accelerators and full power domain 606 is only entered when a predefined number of compute subsystems are active.

Once activated, the lower-power compute resource stores the program state of programs to be transferred to the compute subsystem to memory and transfers the program state of the programs to the compute subsystem (956). The compute subsystem then executes the transferred programs based on the transferred program state (958).

In one example approach, the lower-power compute resource continues to decide whether to bring additional compute subsystems online even if one or more compute subsystems are online. In another example approach, one of the compute subsystems, such as a compute power subsystem 704 having a CPU 705, takes over monitoring for the need to add or subtract additional compute resources.

In some example approaches, SMEM 565 is virtualized as VSMEM. Data to be written to VSMEM is forwarded to either SMEM 565 of local memory of the appropriate subsystem or to off-die memory 566 via DDR Controller 713. As shown in FIG. 7, data to be written to memory 566 may be stored temporarily in a system cache 708 before being transmitted via controller 713 to the appropriate section of memory 566.

The hardware, software, and firmware described above may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted device (HMD) connected to a host computer system, a standalone HMD, a mobile device or computing system, or any other hardware platform capable of providing artificial reality content to one or more viewers.

What is claimed is:

1. A system on a chip (SoC) comprising:
SoC memory;
one or more processor subsystems, wherein each processor subsystem includes a processor connected to the SoC memory; and
a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem,
wherein the low power subsystem is configured to boot up the SoC via the microcontroller executing out of SoC memory.

2. The SoC of claim 1, wherein the SoC memory includes Static Random-Access Memory (SRAM).

3. The SoC of claim 2, wherein the SoC includes a memory management unit configured to be connected to dynamic random-access memory (DRAM), wherein the microcontroller accesses DRAM via the memory management unit when the microcontroller can no longer execute solely out of SRAM.

4. The SoC of claim 3, wherein the PMU is connected to the memory management unit, the PMU operating under the control of the microcontroller to control the power to the memory management unit.

5. The SoC of claim 2, wherein the SRM is distributed to each processor subsystem as local memory, wherein the local memory for each processor subsystem is addressable as shared memory.

6. The SoC of claim 5, wherein portions of each local memory are allocated as a virtualized static memory (VSMEM), with a portion of the local memory serving as a physical address space for the VSMEM and a portion of DRAM serving as storage for data blocks that were replaced in the physical address space of VSMEM.

7. The SoC of claim 1, wherein the processors execute a multi-tasking operating system (MTOS).

8. The SoC of claim 1, wherein the low power subsystem is further configured to transition processes executing on the microcontroller to a selected one or more of the processor subsystems, and to transition processes executing on a selected one of the processor subsystems to the microcontroller,
wherein transitioning processes executing on the microcontroller includes receiving the state of the processes at the selected processor subsystem, and
wherein transitioning processes executing on the selected processor subsystem to the microcontroller includes receiving the state of the processes at the microcontroller.

9. An artificial reality system comprising:
a display screen for a head-mounted display (HMD); and
at least one system on a chip (SoC) connected to the HMD display screen and configured to output artificial reality content on the HMD display screen, wherein the at least one SoC comprises:
SoC memory;
one or more processor subsystems, wherein each processor subsystem includes a processor connected to the SoC memory; and
a low power subsystem integrated as a separate subsystem in the SoC, wherein the low power subsystem includes a microcontroller and a power management unit (PMU), wherein the microcontroller executes a real-time operating system (RTOS), wherein the PMU is connected to each processor subsystem, the PMU operating under the control of the microcontroller to control the power to each processor subsystem,
wherein the low power subsystem is configured to boot up the SoC via the microcontroller executing out of SoC memory.

10. The artificial reality system of claim 9, wherein the SoC memory includes Static Random-Access Memory (SRAM).

11. The artificial reality system of claim 10, wherein the SoC includes a memory management unit configured to be connected to dynamic random-access memory (DRAM), wherein the microcontroller accesses DRAM via the memory management unit when the microcontroller can no longer execute solely out of SRAM.

12. The artificial reality system of claim 11, wherein the PMU is connected to the memory management unit, the PMU operating under the control of the microcontroller to control the power to the memory management unit.

13. The artificial reality system of claim 10, wherein the SRAM is distributed to each processor subsystem as local memory, wherein the local memory for each processor subsystem is addressable as shared memory.

14. The artificial reality system of claim 13, wherein each local memory is allocated as a virtualized static memory (VSMEM), with a portion of the local memory serving as a physical address space for the VSMEM and a portion of DRAM serving as storage for data blocks that were replaced in the physical address space of VSMEM.

15. The artificial reality system of claim 9, wherein the processors execute a multi-tasking operating system (MTOS).

16. In an artificial reality system having a display screen for a head-mounted display (HMD) and at least one system on a chip (SoC) connected to the HMD display screen and configured to output artificial reality content on the HMD display screen, wherein the at least one SoC includes SoC memory, one or more compute subsystems connected to the SoC memory, and a low power subsystem connected to the compute subsystems and the SoC memory, the low power subsystem integrated as a separate subsystem in the SoC, a method comprising:
booting the artificial reality system into a low power compute state, wherein booting includes executing one or more processes in a microcontroller of the low power subsystem;
determining, at the microcontroller, whether to move to one of the higher power compute states; and
if moving to one of the higher power compute states:
selecting one of the one or more compute subsystems, wherein selecting includes supplying power from the PMU to the selected compute subsystem;
selecting one or more of the processes executing in the microcontroller of the low power subsystem, wherein selecting the processes includes saving the state of the selected processes to the SoC memory;
executing the selected processes on the selected compute subsystem, wherein executing includes receiving the state of the selected processes at the selected compute subsystem and executing instructions in the selected compute subsystem to execute the selected processes in the selected compute subsystem based on the received state;
determining, at one of the selected compute subsystems, whether to move to one of the lower power compute states; and
if moving to one of the lower power compute states:
selecting one of the one or more compute subsystems to be deactivated, wherein selecting includes saving, to the SoC memory, the state of the processes executing on the compute subsystem to be deactivated;
configuring the PMU to deactivate the selected compute subsystem; and
executing the selected processes on the microcontroller, wherein executing includes receiving the state of the selected processes at the microcontroller and executing instructions in the microcontroller to execute the selected processes in the microcontroller based on the received state.

17. The method of claim 16, wherein the compute subsystem includes a CPU.

18. The method of claim 16, wherein the compute subsystem includes an accelerator.

19. The method of claim 16, wherein the SoC includes a memory management unit configured to be connected to dynamic random-access memory (DRAM), wherein the microcontroller accesses DRAM via the memory management unit when the microcontroller can no longer execute solely out of SRAM.
